(19) United States
(12) Patent Application Publication
(10) Pub. No.: US 2003/0070117 A1
(43) Pub. Date: Apr. 10, 2003

(54) Simulation apparatus and simulation method

(75) Inventors: Toshio Matsuki, Kyoto-shi (JP); Shigeya Takagi, Nagaokakyo-shi (JP); Hidetaka Matsumoto, Ikeda-shi (JP)

Correspondence Address: MERCHANT & GOULD PC, P.O. BOX 2903, MINNEAPOLIS, MN, 55402-0903, US

(73) Assignee: Matsushita Electric Industrial Co., Ltd., Kadoma-shi (JP)

(21) Appl. No.: 10/247,915

(22) Filed: Sep. 19, 2002

(30) Foreign Application Priority Data
Oct. 4, 2001 (JP) 2001-309178

(51) Int. Cl. H04B 1/74

(52) U.S. Cl. 714/25

(57) ABSTRACT

A simulation apparatus and a simulation method that are inexpensive, can achieve a higher execution speed and can perform simulation without using a peripheral circuit simulator under the same condition as that in the case of incorporating a program in hardware are provided. The simulation apparatus includes a storing portion that stores a program to be debugged containing a control operation of hardware, a debug support function for supporting the control operation and a debug support function management information, a writing portion that writes an instruction for invoking the debug support function into the program to be debugged based on the debug support function management information, an instruction fetching portion that fetches the instruction from the program to be debugged and, if the fetched instruction is the instruction for invoking the debug support function, fetches an instruction from the debug support function, and an instruction executing portion that executes this fetched instruction.

### BACKGROUND OF THE INVENTION

1. Field of the Invention

The present invention relates to a simulation apparatus and a simulation method for debugging a program involving hardware control, for example, a program for a microcomputer mounted on electronic equipment.

2. Description of Related Art

In recent years, the life cycle of electronic equipment on which microcomputers are mounted has become shorter and shorter, which has made it necessary to shorten also a time period for developing microcomputer programs. Accordingly, there has been an increasing demand for debugging microcomputer programs before completing hardware. Listed below are conventional methods for debugging microcomputer programs without using the hardware in which the microcomputer is to be incorporated.

The first conventional method compiles microcomputer programs using a compiler for a general purpose computer and executes them so that these programs can be executed on a general purpose computer such as a personal computer. When the microcomputer programs are described in a language specification equivalent to that of the compiler for the general purpose computer, the compilation and execution by the compiler for the general purpose computer are possible and the microcomputer programs can be debugged to a certain extent.

The second conventional method executes simulation of a microcomputer program on a general purpose computer by using a machine instruction simulator, thereby debugging the microcomputer program. FIG. 36 shows a configuration of a machine instruction simulator for performing this second method. As shown in FIG. 36, a machine instruction simulator 100 includes a simulation starting portion 101 for performing an initialization operation for starting simulation, an instruction fetching portion 102 for fetching an instruction from a program to be debugged D1 arranged in a virtual memory and an instruction executing portion 103 for executing the fetched instruction and manipulating a data region D2 on the virtual memory. The machine instruction simulator 100 is realized by operating software on a general purpose computer.

The third conventional method prepares a simulator for simulating an operation of hardware on the periphery of a microcomputer (in the following, referred to as “a peripheral circuit simulator”) in addition to the machine instruction simulator and performs simulation by cooperation of the machine instruction simulator and the peripheral circuit simulator, thereby debugging a microcomputer program.

FIG. 37 shows a configuration of a machine instruction simulator and a peripheral circuit simulator for performing this third method. As shown in FIG. 37, a machine instruction simulator 110 includes a simulation starting portion 111, an instruction fetching portion 112 and an instruction executing portion 113. The instruction executing portion 113 includes an instruction analyzing portion 114 for analyzing the fetched instruction, a memory manipulating portion 115 for manipulating a data region D12 in a virtual memory and a peripheral circuit simulator controlling portion 116 for transmitting and receiving a manipulation signal with respect to a peripheral circuit simulator 117. The simulation starting portion 111 and the instruction fetching portion 112 shown here are the same as those in FIG. 36.

The peripheral circuit simulator 117 includes a signal processing portion 118 for executing a processing according to the manipulation signal received from the peripheral circuit simulator controlling portion 116 and a signal transmitting portion 119 for transmitting the manipulation signal to the peripheral circuit simulator controlling portion 116.

Similarly to that shown in FIG. 36, the machine instruction simulator 110 is realized by operating software on a general purpose computer. The peripheral circuit simulator 117 is configured as a hardware simulator or as a software simulator operating on a general purpose computer.

The fourth conventional method utilizes hardware for emulation (hardware emulator) using a device called FPGA (Field Programmable Gate Array), in which an electric circuit can be reconstructed easily. In this method, since a peripheral circuit necessary for debugging microcomputer programs can be realized in the hardware, it is possible to improve an execution speed of a simulator.

Furthermore, the fifth conventional method describes operations of both hardware and software using a system description language, which has become popular in recent years. The system description language typically provides a better functional description of the software compared with a conventional hardware description language. By using this, peripheral hardware and a microcomputer program can be described at the same time.

This allows debugging using a simulator that can be executed on a general purpose computer, so that after the debugging by the system description language, a final microcomputer program file described in a C language or a C++ language can be generated automatically using a tool. Thus, according to the fifth conventional method, in theory, the microcomputer program that has been generated automatically does not have to be debugged, or the number of debugging processes can be reduced even when the debugging is to be performed.

However, the first conventional method has a problem in that a program described in an assembly language that is unique to a microcomputer cannot be executed. Furthermore, owing to the characteristics of an operating system of a general purpose computer, it is difficult to carry out simulation in a part related to the timing of the microcomputer program.

On the other hand, the second conventional method attempts to solve the above-described problem of the first conventional method by using the machine instruction simulator. However, since the microcomputer program is created for controlling hardware, it is described so as to manipulate the hardware in accordance with a status of this hardware.

Accordingly, since no hardware to be manipulated by the microcomputer program is present and the hardware status does not vary in the second conventional method, many parts in the microcomputer program are not executed. This makes it difficult to carry out debugging, leading to a problem that a sufficient debugging cannot be performed.

In order to avoid this problem, a microcomputer program having a part that waits for a response from a peripheral circuit is modified to a program in which a response has been detected, thereby performing debugging after receiving a response.

However, according to this method, since there are innumerable points to be modified, the file management of the microcomputer becomes complicated in the process of carrying out the modification and debugging. This causes a further problem that bugs are generated, deteriorating the reliability of the program.

In the third conventional method, since simulation can be performed under the same condition as that when a microcomputer program is incorporated in actual hardware, it is possible to solve the above-described problem of the second conventional method.

However, in this third method, since a technical skill for producing a necessary peripheral circuit simulator is totally different from that for creating the microcomputer program, there is a problem that it is practically difficult to find engineers who have such a technical skill. Also, the machine instruction simulator and the peripheral circuit simulator transmit and receive output and input signals by some kind of communication between them. An overhead of this communication processing causes a further problem in that an execution speed of the microcomputer program declines.

Moreover, when the hardware simulator is used as the peripheral circuit simulator, a description of hardware that can be realized as a physical electronic circuit is executed by the simulator, so that a processing amount of the simulation increases due to a description that can be realized physically. Furthermore, since the hardware simulator attempts to reproduce physical analog characteristics, it is much slower than a machine instruction simulator. Consequently, there is a problem that an original purpose of debugging a microcomputer program sufficiently before the completion of hardware cannot be achieved.

Although the fourth conventional method can solve the problem of the third conventional method by using the hardware emulator, there still is a problem that the hardware emulator is very expensive. Also, since a circuit on the hardware emulator is hard to debug, it is extremely difficult to use the hardware emulator for developing microcomputer programs.

Furthermore, in the fifth conventional method, although the simulation speed is higher than that in the case of using the conventional hardware simulator, it is not fast enough to debug microcomputer programs. In addition, since the system description language is achieved by developing the hardware description language, it is not understood easily by microcomputer-program developers, and thus engineers who understand the system description language are needed as well.

Although the system description language is suitable for a rough verification at a system level, the difference between the specification of the system description language and the description language of the microcomputer programs makes it difficult to complete the designing and debugging of a program having details at a level mountable on a product by the system description language alone.

Recently, in order to reduce the hardware dependency of microcomputer programs, a virtual machine is configured by the microcomputer programs, on which an application is executed. An example thereof includes a program described in a Java language, which operates in a cellular phone or the like.

In the case of an application with substantially no hardware dependency, microcomputer programs can be developed by debugging by simulation on a general purpose computer. Although it is desirable in terms of shortening a development period that the debugging be completed without using hardware as described above, an application requiring hardware control needs some kind of peripheral circuit simulator, and thus has the same problem as in the case of debugging the microcomputer programs.

### SUMMARY OF THE INVENTION

It is an object of the present invention to solve the problems described above and to provide a simulation apparatus and a simulation method that are inexpensive, can achieve a higher execution speed and can perform simulation without using a peripheral circuit simulator under the same condition as that in the case of incorporating a program in hardware.

In order to achieve the above-mentioned object, a first simulation apparatus according to the present invention is a simulation apparatus used for debugging a program containing a control operation of hardware. The apparatus includes a storing portion that stores at least the program serving as a subject for debugging and a debug support function for supporting a part or a whole of the control operation in the program, a writing portion that writes an instruction for invoking the debug support function instead of the control operation serving as a subject for support, into the program, an instruction fetching portion that fetches an instruction from the program and, if the fetched instruction is the instruction for invoking the debug support function, fetches an instruction from the debug support function, and an instruction executing portion for executing the instruction fetched from the program or the debug support function.

In the above first simulation apparatus, the instruction for invoking the debug support function can be an identification instruction indicating that the control operation is the subject for support or a branch instruction to the debug support function.

In order to achieve the above-mentioned object, a second simulation apparatus according to the present invention is a simulation apparatus used for debugging a program containing a control operation of hardware. The apparatus includes a storing portion that stores at least the program serving as a subject for debugging, a debug support function for supporting a part or a whole of the control operation in the program and a starting address of the control operation serving as a subject for support, a judging portion for judging whether a value of a program counter indicates the control operation serving as the subject for support based on a value of the starting address and, if it does, modifying the value of the program counter so as to indicate the debug support function, an instruction fetching portion for fetching an instruction from the program or the debug support function according to the program counter, and an instruction executing portion for executing the instruction fetched from the program or the debug support function.

In the above second simulation apparatus, it is preferable that the storing portion further stores an ending address of the debug support function or stores an ending address of the debug support function, instead of the starting address of the control operation serving as the subject for support, and that the judging portion judges whether the value of the program counter and the value of the ending address match and, if they do, modifies the value of the program counter so as to indicate the control operation serving as the subject for support.

The above second simulation apparatus also may have the configuration in which the storing portion stores an ending address of the control operation serving as the subject for support and a starting address of the debug support function, instead of the starting address of the control operation serving as the subject for support, and that the judging portion judges whether the value of the program counter indicates an ending of the control operation serving as the subject for support based on a value of the ending address and, if it judges that the value of the program counter indicates the ending of the control operation serving as the subject for support, modifies the value of the program counter so as to indicate the debug support function.

In order to achieve the above-mentioned object, a third simulation apparatus according to the present invention is a simulation apparatus used for debugging a program containing a control operation of hardware. The apparatus includes a storing portion that stores at least the program serving as a subject for debugging, a debug support function for supporting a part or a whole of the control operation in the program and an ending address of the debug support function, a writing portion that writes an instruction for invoking the debug support function instead of an ending instruction of the control operation serving as a subject for support into the program and saves the ending instruction of the control operation serving as the subject for support in a region in the storing portion other than a region storing the program, an instruction fetching portion that fetches an instruction from the program and, if the fetched instruction is the instruction for invoking the debug support function, fetches an instruction from the debug support function, an instruction executing portion for executing the instruction fetched from the program or the debug support function, and a save operation executing portion that judges whether the value of the program counter and the value of the ending address of the debug support function match and, if they do, executes the ending instruction of the control operation that has been saved.

In order to achieve the above-mentioned object, a fourth simulation apparatus according to the present invention is a simulation apparatus used for debugging a program containing a control operation of hardware. The apparatus includes a storing portion that stores at least the program serving as a subject for debugging and a debug support function for supporting a part or a whole of the control operation in the program, a writing portion that writes an instruction for invoking the debug support function instead of a starting instruction of the control operation serving as a subject for support into the program and saves the starting instruction of the control operation serving as the subject for support in a region in the storing portion other than a region storing the program, an instruction fetching portion that fetches an instruction from the program and, if the fetched instruction is the instruction for invoking the debug support function, fetches an instruction from the debug support function, an instruction executing portion for executing the instruction fetched from the program or the debug support function, and a save operation executing portion that judges whether the debug support function has ended and, if it has, executes the starting instruction of the control operation that has been saved.

In order to achieve the above-mentioned object, a fifth simulation apparatus according to the present invention is a simulation apparatus used for debugging a program containing a control operation of hardware. The apparatus includes a storing portion that stores at least the program serving as a subject for debugging and a debug support function for supporting an instruction that performs the control operation in the program and accesses a memory region, an instruction fetching portion for fetching an instruction from the program or the debug support function, a judging portion for judging whether the fetched instruction is an instruction serving as the subject for support, a save operation portion that saves the fetched instruction and a context and generates a stack frame for invoking the debug support function, and makes the instruction fetching portion fetch the instruction from the debug support function, if the judging portion judges that the fetched instruction is the instruction serving as the subject for support, a return operation portion for judging whether the fetched instruction is an ending instruction of the debug support function and, if it is, returning the instruction and the context that have been saved, and an instruction executing portion for executing the instruction fetched from the program or the debug support function.

The above fifth simulation apparatus according to the present invention also may have the configuration in which the judging portion judges whether the instruction executed by the instruction executing portion is the instruction serving as the subject for support, the save operation portion saves the context and generates the stack frame for invoking the debug support function, and makes the instruction fetching portion fetch the instruction from the debug support function, if the judging portion judges that the executed instruction is the instruction serving as the subject for support, and the return operation portion judges whether the instruction fetched from the debug support function is the ending instruction of the debug support function, returns the context that has been saved if it is and makes the instruction executing portion execute the instruction fetched from the debug support function if it is not.

In order to achieve the above-mentioned object, a sixth simulation apparatus according to the present invention is a simulation apparatus used for debugging a program containing a control operation of hardware. The apparatus includes a storing portion that stores at least the program serving as a subject for debugging, a debug support function for supporting a part or a whole of the control operation in the program and an execution starting time of the debug support function based on a time when an execution of the program starts, an instruction fetching portion for fetching an instruction from the program or the debug support function, an instruction executing portion for executing the instruction fetched from the program or the debug support function, a total time calculating portion for calculating a total time from a start of the program to an end of the execution of the instruction by the instruction executing portion, a time judging portion for judging whether a value of the total time is equal to or larger than a value of the execution starting time of the debug support function, a save operation portion that saves a context and generates a stack frame for invoking the debug support function, and makes the instruction fetching portion fetch the instruction from the debug support function, if the time judging portion judges that the value of the total time is equal to or larger than the value of the execution starting time of the debug support function, and a return operation portion for judging whether the instruction fetched from the debug support function is an ending instruction of the debug support function, returning the context that has been saved if it is and making the instruction executing portion execute the instruction fetched from the debug support function if it is not.

In order to achieve the above-mentioned object, a seventh simulation apparatus according to the present invention is a simulation apparatus used for debugging a program containing a control operation of hardware. The apparatus includes a storing portion that stores at least the program serving as a subject for debugging and a debug support function for supporting a part or a whole of the control operation in the program, an instruction fetching portion for fetching an instruction from the program or the debug support function, an instruction executing portion for executing the instruction fetched from the program or the debug support function, an execution time totalling portion for calculating an execution time from a start of the program, a start-of-execution detecting portion for detecting a start of an execution of the debug support function, making the execution time totalling portion suspend the totalization of the execution time when the start of the execution is detected, and making the instruction fetching portion fetch the instruction from the debug support function, and an end-of-execution detecting portion for detecting an end of the execution of the debug support function, making the execution time totalling portion resume the totalization of the execution time when the end of the execution is detected, and making the instruction fetching portion fetch the instruction from the program serving as the subject for debugging.

In order to achieve the above-mentioned object, an eighth simulation apparatus according to the present invention is a simulation apparatus used for debugging a program containing a control operation of hardware. The apparatus includes a storing portion that stores at least the program serving as a subject for debugging and a debug support function for supporting a part or a whole of the control operation in the program, an instruction fetching portion for fetching an instruction from the program or the debug support function, an instruction executing portion for executing the instruction fetched from the program or the debug support function, a break request detecting portion that detects a break request and, when the break request is detected, saves a context, generates a stack frame for invoking the debug support function and makes the instruction fetching portion fetch the instruction from the debug support function, and a return operation portion for judging whether the instruction fetched from the debug support function is an ending instruction of the debug support function and, if it is, returning the context that has been saved.

Next, in order to achieve the above-mentioned object, a first simulation method according to the present invention is a simulation method used for debugging a program containing a control operation of hardware. The method includes (a) obtaining a debug support function for supporting a part or a whole of the control operation in the program serving as a subject for debugging, (b) writing an instruction for invoking the debug support function instead of the control operation serving as a subject for support, into the program, (c) fetching the instruction from the program, (d) judging whether the fetched instruction is the instruction for invoking the debug support function, (e) if it is, fetching an instruction from the debug support function, and (f) executing the instruction fetched from the program or the debug support function.

In the above first simulation method, the instruction for invoking the debug support function can be an identification instruction indicating that the control operation is the subject for support or a branch instruction to the debug support function.

In order to achieve the above-mentioned object, a second simulation method according to the present invention is a simulation method used for debugging a program containing a control operation of hardware. The method includes (a) obtaining a debug support function for supporting a part or a whole of the control operation in the program serving as a subject for debugging and a value of a starting address of the control operation to be supported by the debug support function, (b) judging whether a value of a program counter indicates the control operation serving as the subject for support based on the obtained value of the starting address, (c) if it does, modifying the value of the program counter so as to indicate the debug support function, (d) fetching an instruction from the program or the debug support function according to the program counter, and (e) executing the instruction fetched from the program or the debug support function.

In order to achieve the above-mentioned object, in the second simulation method according to the present invention, it is preferable that in obtaining the value of the starting address of the control operation, a value of an ending address of the debug support function further is obtained or a value of an ending address of the debug support function, instead of the value of the starting address of the control operation to be supported by the debug support function further is obtained. Preferably, the second simulation method further includes judging whether the value of the program counter and the value of the ending address match and, if they do, modifying the value of the program counter so as to indicate the control operation serving as the subject for support.

In order to achieve the above-mentioned object, the second simulation method according to the present invention further can include, in the (a) obtaining step, obtaining a value of an ending address of the control operation to be supported by the debug support function and a value of a starting address of the debug support function, instead of the value of the starting address of the control operation to be supported by the debug support function; in the (b) judging step, judging whether the value of the program counter indicates an ending of the control operation serving as the subject for support based on the obtained value of the ending address; and in the (c) modifying step, if the value of the program counter indicates the ending of the control operation serving as the subject for support, modifying the value of the program counter so as to indicate the debug support function.

In order to achieve the above-mentioned object, a third simulation method according to the present invention is a simulation method used for debugging a program containing a control operation of hardware. The method includes (a) obtaining at least a debug support function for supporting a part or a whole of the control operation in the program serving as a subject for debugging and an ending address of the debug support function, (b) writing an instruction for invoking the debug support function instead of an ending instruction of the control operation serving as a subject for support, into the program, (c) saving the ending instruction of the control operation serving as the subject for support in a region in the storing portion other than a region storing the program, (d) fetching the instruction from the program, (e) judging whether the fetched instruction is an instruction for invoking the debug support function, (f) if it is, fetching an instruction from the debug support function, (g) executing the instruction fetched from the program or the debug support function, (h) judging whether a value of a program counter and a value of the ending address of the debug support function match, and (i) if they do, executing the saved ending instruction of the control operation.

In order to achieve the above-mentioned object, a fourth simulation method according to the present invention is a simulation method used for debugging a program containing a control operation of hardware. The method includes (a) obtaining at least a debug support function for supporting a part or a whole of the control operation in the program serving as a subject for debugging, (b) writing an instruction for invoking the debug support function instead of the starting instruction of the control operation serving as a subject for support, into the program, (c) saving the starting instruction of the control operation serving as the subject for support in a region in the storing portion other than a region storing the program, (d) fetching an instruction from the program, (e) judging whether the fetched instruction is an instruction for invoking the debug support function, (f) if it is, fetching an instruction from the debug support function, (g) executing the instruction fetched from the program or the debug support function, (h) judging whether the debug support function has ended, and (i) if it has, executing the saved starting instruction of the control operation.

In order to achieve the above-mentioned object, a fifth simulation method according to the present invention is a simulation method used for debugging a program containing a control operation of hardware. The method includes (a) obtaining a debug support function for supporting an instruction that performs the control operation in the program serving as a subject for debugging and accesses a memory region, (b) fetching an instruction from the program, (c) judging whether the fetched instruction is an instruction serving as the subject for support, (d) if it is, saving the fetched instruction and a context, generating a stack frame for invoking the debug support function, and fetching an instruction from the debug support function, (e) judging whether the fetched instruction is an ending instruction of the debug support function, (f) if it is, returning the instruction and the context that have been saved, and (g) executing the instruction fetched from the program or the debug support function.

The fifth simulation method according to the present invention further may include, before the (c) judging step, executing the instruction fetched from the program; in the (c) judging step, judging whether the instruction fetched from the program and executed instead of the fetched instruction is the instruction serving as the subject for support; in the (d) saving step, generating and fetching, if the instruction fetched from the program and executed is judged to be the instruction serving as the subject for support in the (c) judging step, saving the context and generating the stack frame for invoking the debug support function, and fetching the instruction from the debug support function; and in the (g) executing step, if the fetched instruction is judged not to be the ending instruction of the debug support function in the (e) judging step, executing the instruction fetched from the debug support function.

In order to achieve the above-mentioned object, a sixth simulation method according to the present invention is a simulation method used for debugging a program containing a control operation of hardware. The method includes (a) obtaining a debug support function for supporting a part or a whole of the control operation in the program serving as a subject for debugging and an execution starting time of the debug support function based on a time when an execution of the program starts, (b) fetching an instruction from the program, (c) executing the instruction fetched from the program, (d) calculating a total time from a start of the program to an end of the execution of the instruction, (e) judging whether a value of the total time is equal to or larger than a value of the execution starting time of the debug support function, (f) if the value of the total time is equal to or larger than the value of the execution starting time of the debug support function, saving a context and generating a stack frame for invoking the debug support function, and fetching an instruction from the debug support function, and (g) judging whether the instruction fetched from the debug support function is an ending instruction of the debug support function, (h) if it is, returning the context that has been saved, and (i) if it is not, executing the instruction fetched from the debug support function.

In order to achieve the above-mentioned object, a seventh simulation method according to the present invention is a simulation method used for debugging a program containing a control operation of hardware. The method includes (a) obtaining a debug support function for supporting a part or a whole of the control operation in the program, (b) fetching an instruction from the program, (c) executing the instruction fetched from the program, (d) totalizing an execution time from a start of the program, (e) detecting a start of an execution of the debug support function, (f) when the start of the execution of the debug support function is detected, suspending the totalization of the execution time, fetching the instruction from the debug support function and executing it, (g) detecting an end of the execution of the debug support function, and (h) when the end of the execution of the debug support function is detected, resuming the totalization of the execution time.

In order to achieve the above-mentioned object, an eighth simulation method according to the present invention is a simulation method used for debugging a program containing a control operation of hardware. The method includes (a) obtaining a debug support function for supporting a part or a whole of the control operation in the program serving as a subject for debugging, (b) fetching an instruction from the program, (c) detecting a break request, (d) when no break request is detected, executing the instruction fetched from the program, (e) when the break request is detected, saving a context, generating a stack frame for invoking the debug support function and fetching an instruction from the debug support function, (f) judging whether the instruction fetched from the debug support function is an ending instruction of the debug support function, (g) if it is, returning the context that has been saved, and (h) if it is not, executing the instruction fetched from the debug support function.

Furthermore, the present invention may be a program for realizing the above-described first to eighth simulation methods according to the present invention. In this case, such a program is installed on a computer and executed, thereby realizing the above-described first to eighth simulation apparatuses according to the present invention. Incidentally, “a function” in the present specification includes a subroutine and a module.

The simulation apparatus and the simulation method according the present invention is characterized in that, instead of a function for conducting a control operation serving as a subject for support, or before/after executing this function, a debug support program can be executed on the same simulator as described above. On the other hand, a conventional peripheral circuit simulator is provided outside a simulator of a microcomputer program, posing problems in a simulation speed and the number of processes for developing models of peripheral circuits.

As described above, according to the simulation apparatus and the simulation method of the present invention, a source file of a program to be debugged is not modified at all, and only by linking a program for supporting debugging (a debug support function) with the program to be debugged, it becomes possible to perform a wide-range debugging without any special peripheral circuit simulator as used conventionally. Furthermore, since the source file of the program to be debugged does not have to be modified, bugs owing to a side effect of debugging can be minimized. Moreover, the execution of the program to be debugged and that of the debug support program can be switched at a high speed, thus improving the debug efficiency.

Also, since a program that supports debugging can be debugged for itself in the simulation apparatus and the simulation method of the present invention, the debugability and maintenability of them are excellent. Furthermore, when the program that supports debugging is allowed to be compiled also with the same compiler as that for the program to be debugged, it is possible to eliminate the need for a special period for learning a description language, so that even a microcomputer-program designer can create easily a program for supporting debugging operation for a simulation debugging. As a result, even a general microcomputer-program developer becomes able to debug the simulation sufficiently and easily, thus shortening a time period for developing microcomputer programs.

In addition, the simulation apparatus and the simulation method according to the present invention are effective in debugging an application that controls hardware operating on a virtual machine because they can shorten the development period.

### BRIEF DESCRIPTION OF THE DRAWINGS

FIG. 1 shows a configuration of a simulation apparatus according to a first embodiment of the present invention.

FIG. 2 is a flowchart showing a simulation method and a process flow of the simulation apparatus shown in FIG. 1 according to the first embodiment of the present invention.

FIG. 3 illustrates examples of a program to be debugged and a debug support function.

FIG. 4 illustrates an example of debug support function management information.

FIG. 5 is a flowchart showing a writing operation of a support function identification instruction shown in FIG. 2.

FIG. 6 is a flowchart showing an instruction fetching operation shown in FIG. 2.

FIG. 7 is a flowchart showing a detecting operation of the support function identification instruction shown in FIG. 2.

FIG. 8 is a flowchart showing a program counter modifying operation shown in FIG. 2.

FIG. 9 is a flowchart showing a simulation method and a process flow of a simulation apparatus according to a second embodiment of the present invention.

FIG. 10 is a flowchart showing a writing operation of a branch instruction shown in FIG. 9.

FIG. 11 shows a configuration of a simulation apparatus according to a third embodiment of the present invention.

FIG. 12 is a flowchart showing a simulation method and a process flow of the simulation apparatus shown in FIG. 11 according to the third embodiment of the present invention.

FIG. 13 is a flowchart showing a simulation method and a process flow of a simulation apparatus according to a fourth embodiment of the present invention.

FIG. 14 illustrates examples of a program to be debugged and a debug support function used in the fourth embodiment.

FIG. 15 shows a configuration of a simulation apparatus according to a fifth embodiment of the present invention.

FIG. 16 is a flowchart showing a simulation method and a process flow of the simulation apparatus shown in FIG. 15 according to the fifth embodiment of the present invention.

FIG. 17 illustrates examples of a program to be debugged and a debug support function used in the fifth embodiment.

FIG. 18 shows a configuration of a simulation apparatus according to a sixth embodiment of the present invention.

FIG. 19 is a flowchart showing a simulation method and a process flow of the simulation apparatus shown in FIG. 18 according to the sixth embodiment of the present invention.

FIG. 20 illustrates debug support function management information in the sixth embodiment.

FIG. 21 illustrates examples of a program to be debugged and a debug support function used in the sixth embodiment.

FIG. 22 is a flowchart showing a simulation method and a process flow of a simulation apparatus according to a seventh embodiment of the present invention.

FIG. 23 illustrates debug support function management information in the seventh embodiment.

FIG. 24 illustrates examples of a program to be debugged and a debug support function used in the seventh embodiment.

FIG. 25 shows a configuration of a simulation apparatus according to an eighth embodiment of the present invention.

FIG. 26 is a flowchart showing a simulation method and a process flow of the simulation apparatus shown in FIG. 25 according to the eighth embodiment of the present invention.

FIG. 27 illustrates debug support function management information in the eighth embodiment.

FIG. 28 illustrates examples of a program to be debugged and a debug support function used in the eighth embodiment.

FIG. 29 shows a configuration of a simulation apparatus according to a ninth embodiment of the present invention.

FIG. 30 is a flowchart showing a simulation method and a process flow of the simulation apparatus shown in FIG. 29 according to the ninth embodiment of the present invention.

FIG. 31A shows how the time required for executing from start to end a program to be debugged becomes longer in the case where a debug support function is executed, and FIG. 31B shows how the time required for executing the debug support function is not calculated into a total time in the eighth embodiment.

FIG. 32 shows a configuration of a simulation apparatus according to a tenth embodiment of the present invention.

FIG. 33 is a flowchart showing a simulation method and a process flow of the simulation apparatus shown in FIG. 32 according to the tenth embodiment of the present invention.

FIG. 34 illustrates an example of debugging using a simulation apparatus and a simulation method according to the present invention.

FIG. 35 is a flowchart showing another example in the fourth embodiment.

FIG. 36 shows a configuration of a machine instruction simulator for carrying out a second conventional method.

FIG. 37 shows a configuration of a machine instruction simulator and a peripheral circuit simulator for carrying out a third conventional method.

### DESCRIPTION OF THE PREFERRED EMBODIMENTS

First Embodiment

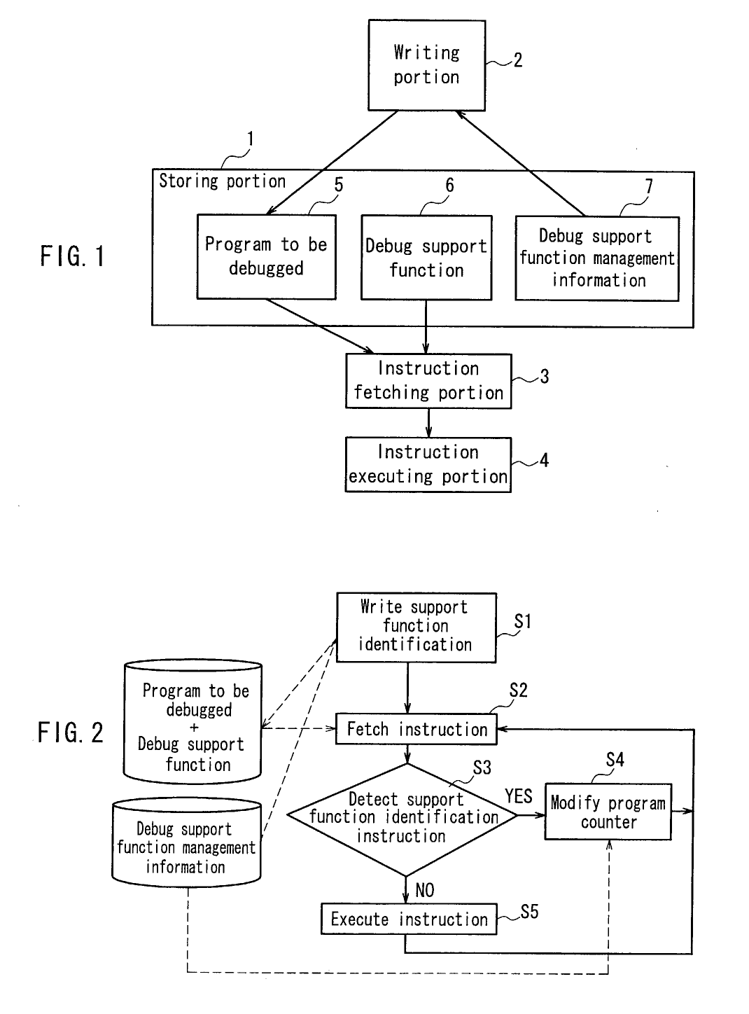

The following is a description of a simulation apparatus and a simulation method according to the first embodiment of the present invention, with reference to FIGS. 1 to 8. The simulation apparatus and the simulation method according to the first embodiment are used for debugging a program containing a control operation of hardware, for example, a microcomputer program to be incorporated in electronic equipment on which a microcomputer is mounted. It should be understood that those of the second to tenth embodiments described later also are used similarly.

FIG. 1 shows a configuration of the simulation apparatus according to the first embodiment of the present invention. FIG. 2 is a flowchart showing the simulation method and a process flow of the simulation apparatus shown in FIG. 1 according to the first embodiment of the present invention. In the simulation apparatus and the simulation method according to the present embodiment, a function of performing a hardware control operation contained in a program serving as a subject for debugging (in the following, referred to as “a program to be debugged”) is not executed, and a debug support function of supporting this control operation is executed instead. The former function of performing the control operation is referred to as “a supported debug function” in the following. The control operation to be supported by the debug support function in the present invention may be a part or a whole of the control operation contained in the program to be debugged.

First, the configuration of the simulation apparatus according to the first embodiment will be described referring to FIG. 1. As shown in FIG. 1, the simulation apparatus according to the present embodiment includes a storing portion 1, a writing portion 2, an instruction fetching portion 3 and an instruction executing portion 4.

The storing portion 1 in the present embodiment stores a program to be debugged 5, a debug support function 6 of supporting a control operation contained in the program to be debugged 5 and debug support function management information 7. There are a plurality of the debug support functions 6 that are of different types from each other.

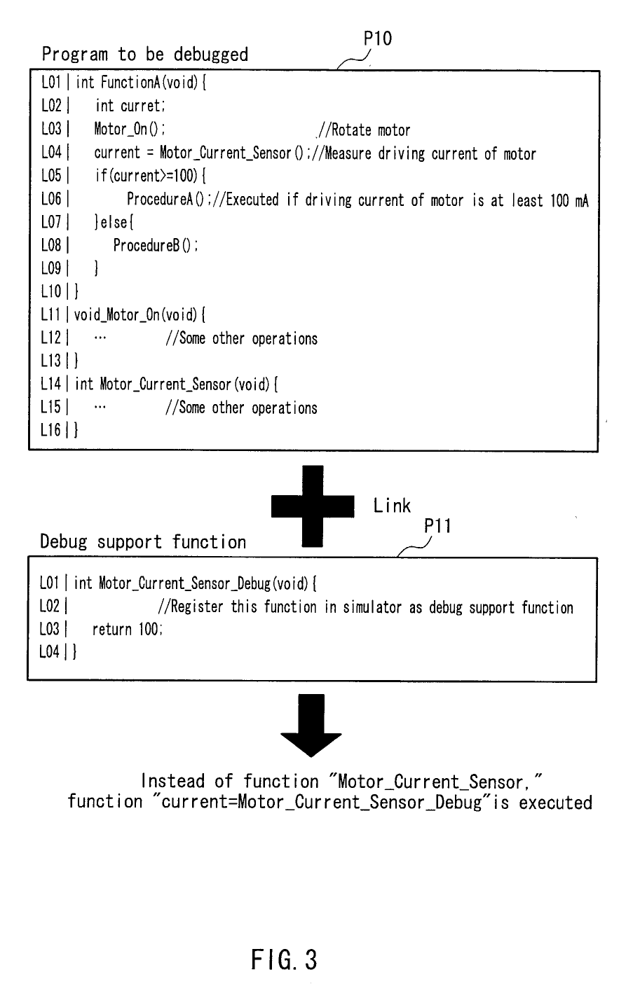

Herein, the program to be debugged 5, the debug support functions 6 and the debug support function management information 7 will be described by way of specific examples. FIG. 3 illustrates examples of the program to be debugged and the debug support function. In a program to be debugged P10 shown in FIG. 3, a supported debug function “int Motor_Current_Sensor (void)” with a line number L14 is supported by “int Motor_Current_Sensor_Debug (void)” with a line number L01 in a debug support function P11.

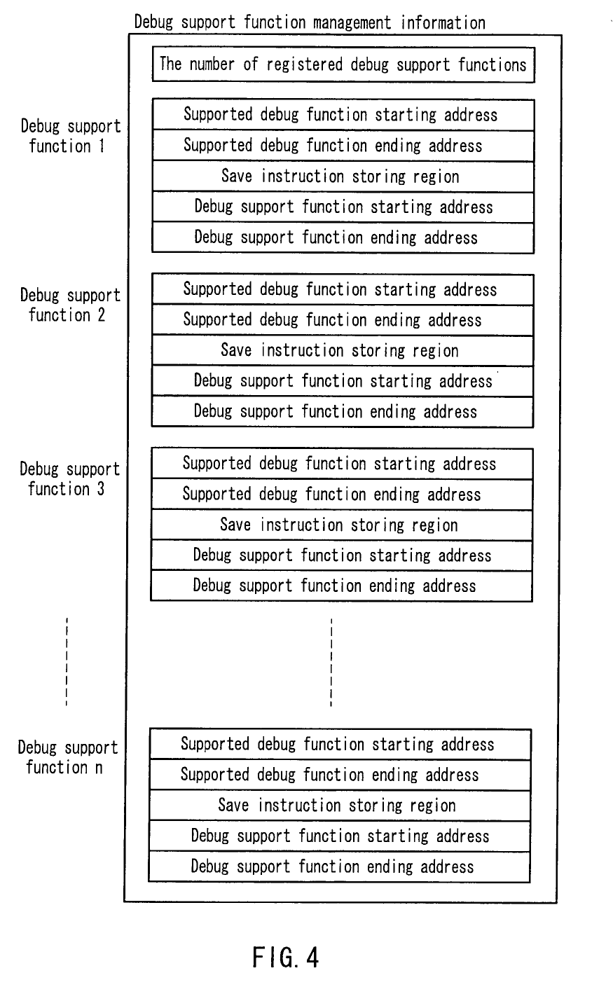

FIG. 4 illustrates an example of the debug support function management information. As shown in FIG. 4, the storing portion 1 stores the number of registered debug support functions, a supported debug function starting address, a supported debug function ending address, a debug support function starting address and a debug support function ending address, as the debug support function management information 7. The supported debug function starting address, the supported debug function ending address, the debug support function starting address and the debug support function ending address are stored by each debug support function. Furthermore, in a region of the storing portion 1 storing the debug support function management information 7, a save instruction storing region for storing temporarily the supported debug function during the execution of the debug support function is reserved by each debug support function.

The simulation apparatus according to the first embodiment is realized by installing on a computer a program for realizing the simulation method according to the first embodiment, which will be described below referring to FIG. 2. Thus, the storing portion is realized by a recording medium in a hard disk, a RAM, a register, a cache memory etc. to be provided in the computer. Also, the writing portion 2, the instruction fetching portion 3 and the instruction executing portion 4 are realized by a central processing unit (CPU) provided in the computer.

Next, referring to FIG. 2, the simulation method and an operation in each portion in the simulation apparatus shown in FIG. 1 will be described according to the first embodiment. The description accompanies suitable references to FIG. 1 because the simulation method shown in FIG. 2 is carried out by running the simulation apparatus shown in FIG. 1 in the present embodiment.

First, the program to be debugged and the debug support function are obtained. In the present embodiment, they already have been obtained by the storing portion 1 as shown in FIG. 1. Thus, this operation is omitted in FIG. 2.

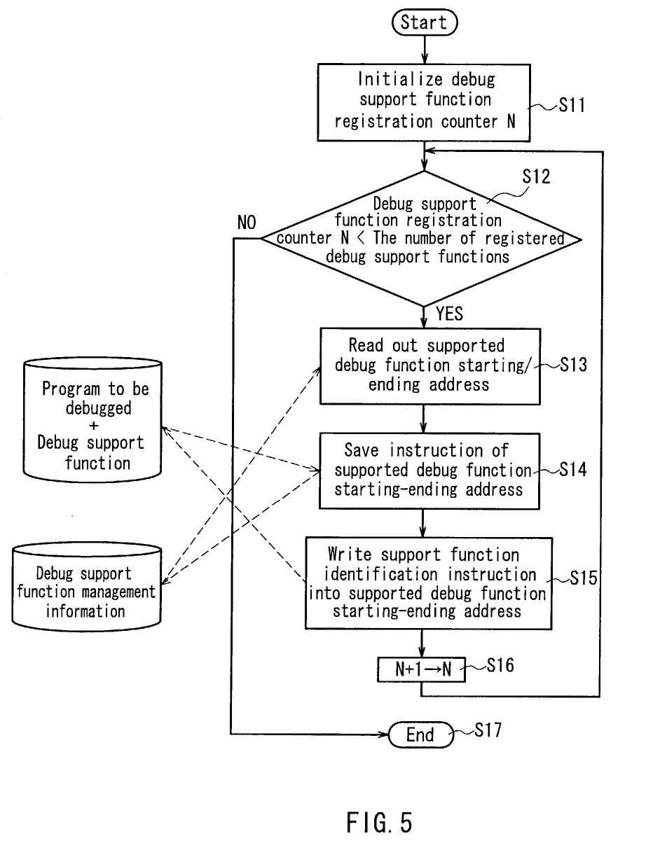

Next, as shown in FIG. 2, the writing portion 2 writes into the program to be debugged a support function identification instruction for invoking the debug support function (operation S1). More specifically, the writing portion 2 rewrites a preceding instruction of the supported debug function “Motor_Current_Sensor ( )” in the program to be debugged P10 shown in FIG. 3 into the debug support function identification instruction, based on the debug support function management information shown in FIG. 4. The operation S1 will be detailed later in FIG. 5.

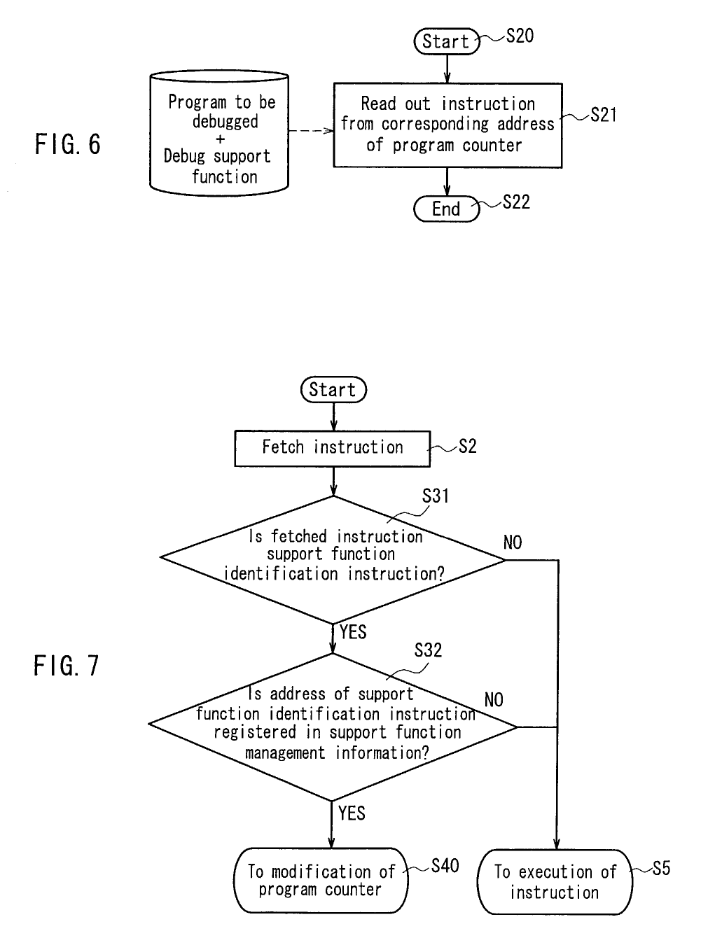

Then, the instruction fetching portion 3 fetches an instruction from the program to be debugged (operation S2) and judges whether the fetched instruction is the support function identification instruction written in the operation S1 (operation S3). The operation S2 and the operation S3 will be detailed later in FIGS. 6 and 7, respectively.

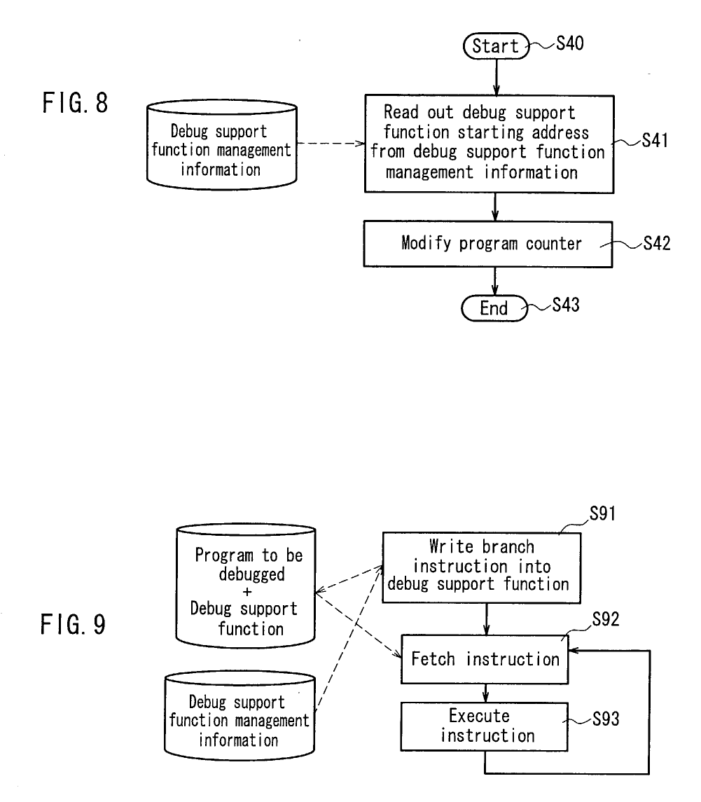

If the fetched instruction is not the support function identification instruction, the operation moves to the next operation S5. If the fetched instruction is the support function identification instruction, the instruction fetching portion 3 modifies a program counter (operation S4). More specifically, the instruction fetching portion 3 modifies the current program counter to a preceding address of the debug support function P11 “Motor_Current_Sensor_Debug ( )” shown in FIG. 3 corresponding to the supported debug function, based on the debug support function management information shown in FIG. 4. The operation S4 will be detailed later in FIG. 8.

After the program counter is modified, the instruction fetching portion 3 fetches an instruction from the debug support function 6 (operation S2). An instruction “return 100;” for returning to the next instruction in the program to be debugged is present at the end of the debug support function P11 shown in FIG. 3. Thus, after the execution of the debug support function, an instruction executing operation is shifted to an address after an ending of the supported debug function.

Then, the instruction executing portion 4 executes the instruction fetched from the program to be debugged 5 and the debug support function 6 (operation S5). According to the fetched instruction, the instruction executing portion 4 performs modification of the program counter, writing into the storing portion 1, reading out from the storing portion 1 and calculation. Until the execution of the program to be debugged ends, the operations S1 to S5 described above are executed repeatedly. In this manner, the first embodiment executes the debug support function without executing the supported debug function.

Herein, the operations S1 to S4 shown in FIG. 2 will be described more specifically. FIG. 5 is a flowchart showing a writing operation of a support function identification instruction shown in FIG. 2. As shown in FIG. 5, the writing portion 2 first reserves an arbitrary region in the storing portion 1 as a debug support function registration counter N and writes zero into this region, thereby initializing the debug support function registration counter N (operation S11).

Subsequently, the writing portion 2 reads out the number of registered debug support functions from the debug support function management information shown in FIG. 4 and compares it with respect to the debug support function registration counter N (operation S12). When the result of the comparison indicates that the value of the debug support function registration counter N is equal to or larger than the number of registered debug support functions, the operation ends (operation S17).

On the other hand, when the result of the comparison indicates that the value of the debug support function registration counter N is smaller than the number of registered debug support functions, the writing portion 2 reads out the supported debug function starting address and the supported debug function ending address that are registered from the debug support function management information shown in FIG. 4 (operation S13).

Subsequently, the writing portion 2 saves the instruction of the supported debug function stored from the supported debug function starting address to the supported debug function ending address that are read out, in the save instruction storing region in the debug support function management information (operation S14).

Next, the writing portion 2 replaces the instruction of the supported debug function with a debug support function identification instruction based on the read-out supported debug function starting address to supported debug function ending address (operation S15). Furthermore, the writing portion 2 adds “1” to the value of the debug support function registration counter N (operation S16).

The writing operation of the support function identification instruction by the writing portion 2 (operations S12 to S16) is carried out repeatedly until the value of the debug support function registration counter N reaches the number registered in the debug support function management information, and ends when it reaches this number.

FIG. 6 is a flowchart showing an instruction fetching operation shown in FIG. 2. As shown in FIG. 6, the instruction fetching portion 3 reads out an instruction from the program to be debugged or the debug support function stored in the storing portion 1, according to the current program counter.

FIG. 7 is a flowchart showing a detecting operation of the support function identification instruction shown in FIG. 2. As shown in FIG. 7, the instruction fetching portion 3 first judges whether the instruction fetched in the operation S2 (see FIG. 2) is the support function identification instruction (operation S31). If the result of the judgment indicates that it is not the support function identification instruction, the instruction executing portion 4 executes this instruction (operation S5).

On the other hand, if it is judged to be the support function identification instruction, the instruction fetching portion 3 checks whether a debug support function starting address and a debug support function ending address corresponding to this support function identification instruction are registered in the debug support function management information (operation S32). If they are not registered, the operation branches to the instruction executing operation S5 (see FIG. 2) and executes the instruction of the program to be debugged. If they are registered, the operation branches to the program counter modifying operation S4 (see FIG. 2).

FIG. 8 is a flowchart showing the program counter modifying operation shown in FIG. 2. As shown in FIG. 8, the instruction fetching portion 3 first reads out the debug support function starting address corresponding to the supported debug function indicated by the current program counter from the debug support function management information (operation S41). Next, the instruction fetching portion 3 modifies the current program counter to the read-out address (operation S42). In this manner, the instruction fetching portion 3 fetches the instruction from the debug support function, and this fetched instruction is executed by the instruction executing portion 4.

As described above, in the first embodiment, the program to be debugged (the supported debug function) 5 and the debug support function 6 are stored in the storing portion 1 in advance, and the instruction of a part or a whole of the supported debug function is replaced with the support function identification instruction based on the debug support function management information 7 that manages the relationship between the supported debug function and the debug support function. Furthermore, this replaced support function identification instruction is detected during execution, and the execution of the instruction is shifted to the debug support function.

Accordingly, the value of “current” in the program to be debugged P10 shown in FIG. 3, for example, reaches 100, so that according to the judgment of L05 in the program to be debugged P10, “ProcedureA” in L06 is executed.

In other words, in the first embodiment, only by storing the debug support function in addition to the program to be debugged in the storing portion 1 and designating the relationship between the supported debug function and the debug support function based on the debug support function management information, it is possible to manipulate, for example, the value of “current” in the program to be debugged P10 shown in FIG. 3 without modifying a source program file of a program serving as a subject for debugging.

Moreover, in the first embodiment, since the debug support function also is executed in the same mechanism as that of the supported debug function, the debugging also can be conducted in the similar manner. Furthermore, since a system for executing the debug support function instead of the supported debug function is simple, the debug support function can be executed at a high speed, making it possible to debug microcomputer programs efficiently.

The first embodiment is particularly useful when the microcomputer program has a hierarchical structure, which is divided into a hardware control hierarchy and other hierarchies. In this case, a function group serving as an entry of the hardware control hierarchy easily can be made to behave as if hardware were present.

Second Embodiment

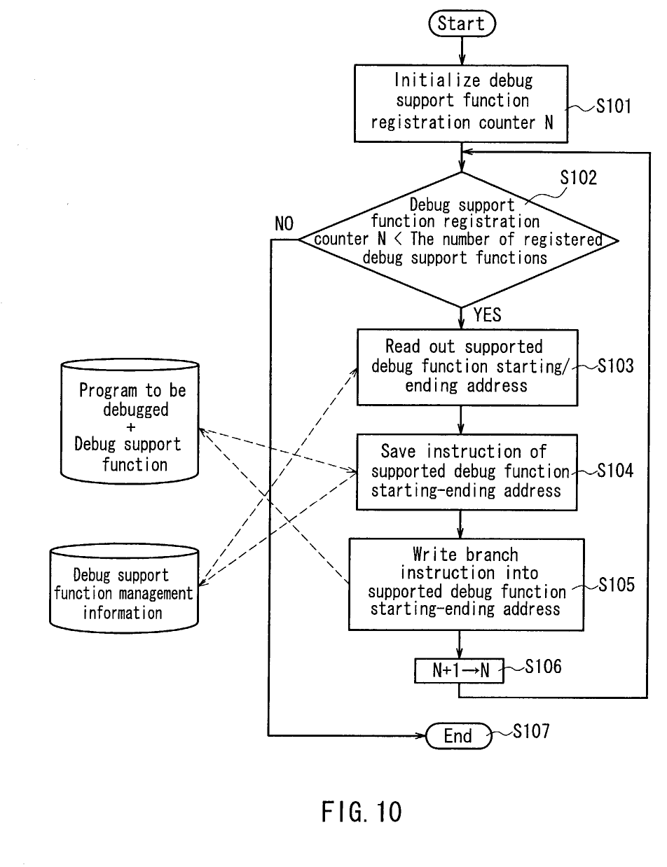

The following is a description of a simulation apparatus and a simulation method according to the second embodiment of the present invention, with reference to FIGS. 9 and 10. FIG. 9 is a flowchart showing the simulation method and a process flow of the simulation apparatus according to the second embodiment of the present invention.

The simulation apparatus and the simulation method according to the second embodiment are similar to those of the first embodiment in that a debug support function is executed instead of a supported debug function contained in a program to be debugged, but are different in that a branch instruction for branching to the debug support function is written into the program to be debugged.

As in the simulation apparatus illustrated in the first embodiment, the simulation apparatus according to the second embodiment includes a storing portion, a writing portion, an instruction fetching portion and an instruction executing portion (see FIG. 1). The simulation apparatus according to the present embodiment is different from that according to the first embodiment in the operations in the writing portion and the instruction fetching portion.

As in the first embodiment, the storing portion includes a program to be debugged, a debug support function of supporting a control operation contained in the program to be debugged and debug support function management information. The program to be debugged and the debug support function shown in FIG. 3 also serve as an example in the second embodiment.

As in the first embodiment, the storing portion stores the number of registered debug support functions, a supported debug function starting address, a supported debug function ending address, a debug support function starting address and a debug support function ending address, as the debug support function management information 7. Furthermore, the storing portion 1 reserves a save instruction storing region for storing temporarily the supported debug function during the execution of the debug support function.

As in the first embodiment, the simulation apparatus according to the second embodiment also is realized by installing a program on a computer. However, unlike the first embodiment, this program realizes a simulation method, which will be described below referring to FIG. 9.

In the following, referring to FIG. 9, the simulation method and an operation in each portion in the simulation apparatus will be described according to the second embodiment. First, the program to be debugged and the debug support function are obtained. In the present embodiment, they also have been obtained already by the storing portion. Thus, this operation also is omitted in FIG. 9.

Next, as shown in FIG. 9, the writing portion writes into the program to be debugged that is stored in the storing portion a branch instruction for executing a branching to the debug support function instead of the supported debug function (operation S91).

More specifically, the writing portion rewrites a starting instruction of the supported debug function “Motor_Current_Sensor ( )” in the program to be debugged P10 shown in FIG. 3, for example, into the branch instruction to “Motor_Current_Sensor_Debug ( )” in the debug support function P11 shown in FIG. 3, based on the debug support function management information. The operation S91 will be detailed later in FIG. 10.

Then, the instruction fetching portion fetches an instruction from the program to be debugged based on a program counter (operation S92), and the instruction executing portion executes the fetched instruction (operation S93). According to the fetched instruction, the instruction executing portion performs modification of the program counter, writing into the storing portion, reading out from the storing portion and calculation.

If the instruction fetched from the program to be debugged is the branch instruction, the instruction executing portion executes this branch instruction, so that the instruction of the debug support function is fetched (operation S92). When the execution of the debug support function ends, an instruction executing operation is shifted to an address after an ending of the supported debug function.

Until the execution of the program to be debugged ends, the operations S91 to S92 described above are executed repeatedly. As described above, the second embodiment also can execute the debug support function without executing the supported debug function.

FIG. 10 is a flowchart showing a writing operation of the branch instruction shown in FIG. 9. As shown in FIG. 10, the writing portion first initializes a debug support function registration counter as in the operation S11 shown in FIG. 5 (operation S101).

Subsequently, the writing portion reads out the number of registered debug support functions from the debug support function management information and compares it with respect to the debug support function registration counter N (operation S102). When the result of the comparison indicates that the value of the debug support function registration counter N is equal to or larger than the number of registered debug support functions, the operation ends (operation S107).

On the other hand, when the result of the comparison indicates that the value of the debug support function registration counter N is smaller than the number of registered debug support functions, the writing portion reads out from the debug support function management information the supported debug function starting address and the supported debug function ending address that are registered therein (operation S103).

Subsequently, the writing portion saves the instruction of the supported debug function stored from the supported debug function starting address to the supported debug function ending address that are read out, in the save instruction storing region in the debug support function management information (operation S104).

Next, the writing portion replaces the instruction of the supported debug function with the branch instruction to the debug support function based on the read-out supported debug function starting address and supported debug function ending address (operation S105). Furthermore, the writing portion adds “1” to the value of the debug support function registration counter N (operation S106).

The writing operation of the branch instruction by the writing portion (operations S102 to S106) is carried out repeatedly until the value of the debug support function registration counter N reaches the number registered in the debug support function management information, and ends when it reaches this number.

As described above, in the second embodiment, the program to be debugged (the supported debug function) and the debug support function are stored in the storing portion in advance, and the instruction of a part or a whole of the supported debug function is replaced with the branch instruction based on the debug support function management information that manages the relationship between the supported debug function and the debug support function, so that the instruction of the debug support function is executed at the time of executing the supported debug function.

Accordingly, as in the first embodiment, the value of “current” in the program to be debugged P10 shown in FIG. 3, for example, reaches 100, so that according to the judgment of L05 in the program to be debugged P10, “ProcedureA” in L06 is executed.

In other words, as in the first embodiment, only by storing the debug support function in addition to the program to be debugged in the storing portion and designating the relationship between the supported debug function and the debug support function based on the debug support function management information, it is possible also in the second embodiment to manipulate, for example, the value of “current” in the program to be debugged P10 shown in FIG. 3 without modifying a source program file of a program serving as a subject for debugging.

In addition, since the second embodiment involves no debug support function detecting operation at the time of judging the support function identification instruction as in the first embodiment, the supported debug function and the debug support function can be switched faster than in the case of the first embodiment.

Third Embodiment

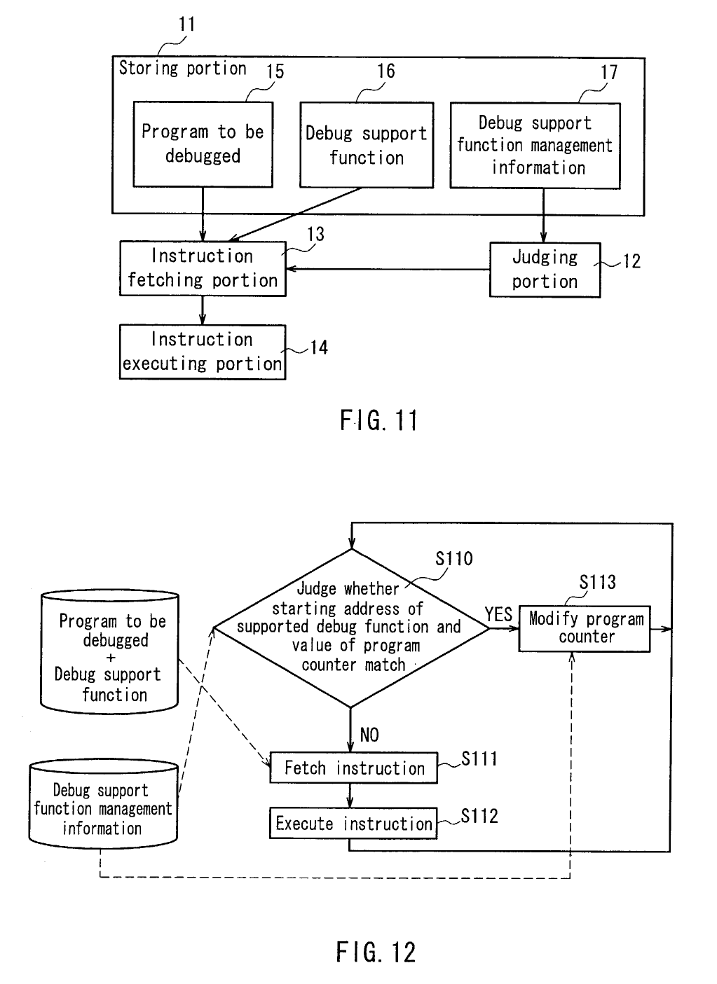

The following is a description of a simulation apparatus and a simulation method according to the third embodiment of the present invention, with reference to FIGS. 11 and 12. FIG. 11 shows a configuration of the simulation apparatus according to the third embodiment of the present invention. FIG. 12 is a flowchart showing the simulation method and a process flow of the simulation apparatus shown in FIG. 11 according to the third embodiment of the present invention.

The simulation apparatus and the simulation method according to the third embodiment are similar to those of the first and second embodiments in that a debug support function is executed instead of a supported debug function contained in a program to be debugged, but are different in that an instruction is not written into the program to be debugged and that a program counter is monitored constantly. The debug support function is also executed instead of the supported debug function when the program counter indicates the supported debug function.

First, the simulation apparatus according to the third embodiment will be described referring to FIG. 11. As shown in FIG. 11, the simulation apparatus according to the present embodiment includes a storing portion 11, a judging portion 12, an instruction fetching portion 13 and an instruction executing portion 14. The present embodiment is different from the first and second embodiments in that the judging portion is provided instead of the writing portion. Accordingly, it becomes possible to realize branching to the debug support function without writing any instruction into the program to be debugged.

The storing portion 11, the instruction fetching portion 13 and the instruction executing portion 14 in the present embodiment are the same as those in the first embodiment. As in the first embodiment, the storing portion 11 stores a program to be debugged 15, a debug support function 16 and debug support function management information 17. The program to be debugged and the debug support function shown in FIG. 3 also serve as an example in the third embodiment.

As in the first embodiment, the storing portion 11 stores the number of registered debug support functions, a supported debug function starting address, a supported debug function ending address, a debug support function starting address and a debug support function ending address, as the debug support function management information 17. However, unlike the first and second embodiments, no save instruction storing region is reserved.

As in the first and second embodiments, the simulation apparatus according to the third embodiment also is realized by installing a program on a computer. However, unlike the first and second embodiments, this program realizes a simulation method, which will be described below referring to FIG. 12.

Now, referring to FIG. 12, the simulation method and an operation in each portion in the simulation apparatus shown in FIG. 11 will be described according to the third embodiment. The description accompanies suitable references to FIG. 11 because the simulation method shown in FIG. 12 is carried out by running the simulation apparatus shown in FIG. 11 in the present embodiment.

First, the program to be debugged, the debug support function and a value of a starting address of a control operation among those contained in the program to be debugged supported by the debug support function (the supported debug function) are obtained. In the present embodiment, they also have been obtained already by the storing portion 11 as shown in FIG. 11. Thus, this operation also is omitted in FIG. 12.

Then, as shown in FIG. 12, the judging portion 12 judges whether a value of a program counter indicates the supported debug function based on the obtained value of the starting address (operation S110). Referring to FIG. 3, the judging portion 12 makes a judgment by comparing a starting address of a supported debug function “Motor_Current_Sensor ( )” in the program to be debugged P10 and the value of the program counter and checking if they match.

If the value of the program counter indicates the supported debug function, in other words, the starting address of the supported debug function and the value of the program counter match, the judging portion 12 modifies the value of the program counter so as to indicate the debug support function based on the debug support function starting address in the debug support function management information 17 (operation S113). Referring to FIG. 3, the judging portion 12 here modifies the value of the program counter to the starting address of “Motor_Current_Sensor_Debug ( )” in the debug support function P11.

If the starting address of the supported debug function and the value of the program counter do not match, the instruction fetching portion 13 fetches an instruction from the program to be debugged or the debug support function stored in the storing portion 11, according to the program counter (operation S111).

Next, the instruction executing portion 14 executes the instruction fetched from the program to be debugged 15 or the debug support function 16 (operation S112). According to the fetched instruction, the instruction executing portion 14 performs modification of the program counter, writing into the storing portion 11, reading out from the storing portion 11 and calculation. Until the execution of the program to be debugged ends, the operations S110 to S113 described above are executed repeatedly. In the case where the debug support function is executed, an instruction executing operation is shifted to an address after an ending of the supported debug function. In this manner, the third embodiment also executes the debug support function without executing the supported debug function.

As described above, in the third embodiment, the program to be debugged (the supported debug function) 15 and the debug support function 16 are stored in the storing portion in advance, the program counter of the supported debug function is monitored based on the debug support function management information 17 that manages the supported debug function and the debug support function, and the program counter is rewritten into the address of the debug support function at the time of executing the supported debug function.

Accordingly, the operation of executing the instruction of the debug support function is conducted. The value of “current” in the program to be debugged P10 shown in FIG. 3, for example, reaches 100, so that according to the judgment of L05 in the program to be debugged P10, “ProcedureA” in L06 is executed.

In other words, as in the first embodiment, only by storing the debug support function in addition to the program to be debugged in the storing portion and designating the relationship between the supported debug function and the debug support function based on the debug support function management information, it is possible also in the third embodiment to, for example, manipulate the value of “current” in the program to be debugged P10 shown in FIG. 3 without modifying a source program file of a program serving as a subject for debugging.

Unlike the first and second embodiments, it is not necessary to replace the instruction in the program to be debugged in the third embodiment. Thus, the simulation apparatus and the simulation method according to the third embodiment are particularly useful when debugging a microcomputer program in the form of ROM. Furthermore, although costs increase when there are many supported debug functions, the instruction can be executed at a high speed by monitoring the program counter by hardware.

Fourth Embodiment

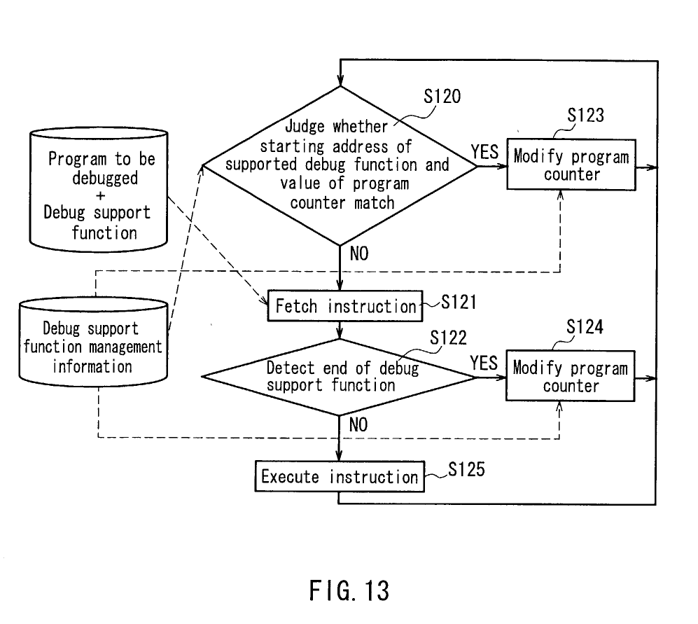

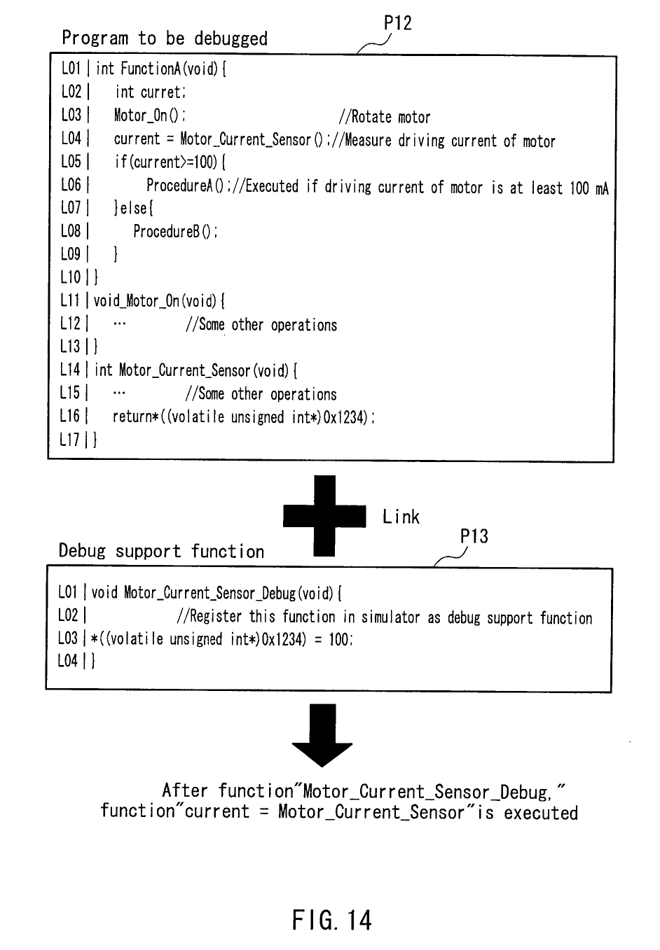

The following is a description of a simulation apparatus and a simulation method according to the fourth embodiment of the present invention, with reference to FIGS. 13 and 14. FIG. 13 is a flowchart showing the simulation method and a process flow of the simulation apparatus according to the fourth embodiment of the present invention.

The simulation apparatus and the simulation method according to the fourth embodiment are similar to those of the third embodiment in that an instruction is not written into the program to be debugged and that a program counter is monitored constantly, but are different in that a supported debug function is executed after executing a debug support function.

First, the simulation apparatus according to the fourth embodiment will be described. As in the simulation apparatus shown in the third embodiment, the simulation apparatus according to the present embodiment includes a storing portion, a judging portion, an instruction fetching portion and an instruction executing portion (see FIG. 11). The simulation apparatus according to the present embodiment is different from that of the third embodiment in the operation of the judging portion.

Also, the content stored in the storing portion is similar to that in the third embodiment, but examples of the program to be debugged and the debug support function are different from those in the first to third embodiments and include those shown in FIG. 14. FIG. 14 illustrates examples of the program to be debugged and the debug support function used in the fourth embodiment. In a program to be debugged P12 shown in FIG. 14, a supported debug function “int Motor_Current_Sensor (void)” with a line number L14 is supported by “void Motor_Current_Sensor_Debug (void)” with a line number L01 in a debug support function P13.

Since the supported debug function is executed after executing the debug support function P13, thereby changing the operation of the program to be debugged P12, the program to be debugged P12 and the debug support function P13 shown in FIG. 14 are different from the program to be debugged P10 and the debug support function P11 shown in FIG. 3 in that the operation changes according to the memory content in the program to be debugged P12 after allowing the memory content to change in the debug support function P13.

As in the first to third embodiments, the simulation apparatus according to the fourth embodiment also is realized by installing a program on a computer. This program realizes a simulation method, which will be described below referring to FIG. 13.

In the following, referring to FIG. 13, the simulation method and an operation in each portion in the simulation apparatus will be described according to the fourth embodiment. First, the program to be debugged, the debug support function, a value of a starting address of a supported debug function and a value of an ending address of a debug support function are obtained. In the present embodiment, they also have been obtained already by the storing portion 11. Thus, this operation also is omitted in FIG. 13. Incidentally, the value of the supported debug function starting address does not have to be obtained in the fourth embodiment.

Then, as shown in FIG. 13, the judging portion judges whether the value of the starting address of the supported debug function matches a value of a program counter (operation S120). This operation is performed similarly to operation S110 shown in the third embodiment.

If the starting address of the supported debug function and the value of the program counter match, the judging portion modifies the value of the program counter, in FIG. 14 for example, to the starting address of “Motor_Current_Sensor_Debug ( )” in the debug support function P13 (operation S123). This operation is performed similarly to operation S113 shown in the third embodiment.

If the starting address of the supported debug function and the value of the program counter do not match, the instruction fetching portion fetches an instruction from the program to be debugged or the debug support function stored in the storing portion, according to the program counter (operation S121). This operation is performed similarly to operation S111 shown in the third embodiment.

In the present embodiment, the judging portion makes another judgment after fetching the instruction. The judging portion judges whether the value of the program counter and the value of the ending address of the debug support function match (operation S122). If they match, the judging portion modifies the value of the program counter so as to indicate the supported debug function (operation S124). In other words, in operation S124, the value of the program counter is made to return to the value before the modification in operation S123.

If they do not match, the instruction executing portion executes the fetched instruction (operation S125). This operation is performed similarly to operation S112 shown in the third embodiment. Until the execution of the program to be debugged ends, the operations S120 to S125 described above are executed repeatedly.

As described above, unlike the first to third embodiments, the operation returns to the supported debug function after executing the debug support function in the fourth embodiment. Thus, when the operation in the supported debug function needs to be executed, it becomes unnecessary to copy this operation into the debug support function, thereby reducing the number of operations for forming the debug support function. When there are many debug support functions, this effect is considerable.

As described above, in the fourth embodiment, the starting address of the supported debug function and the value of the program counter are compared in operation S120, thereby executing the supported debug function after executing the debug support function.

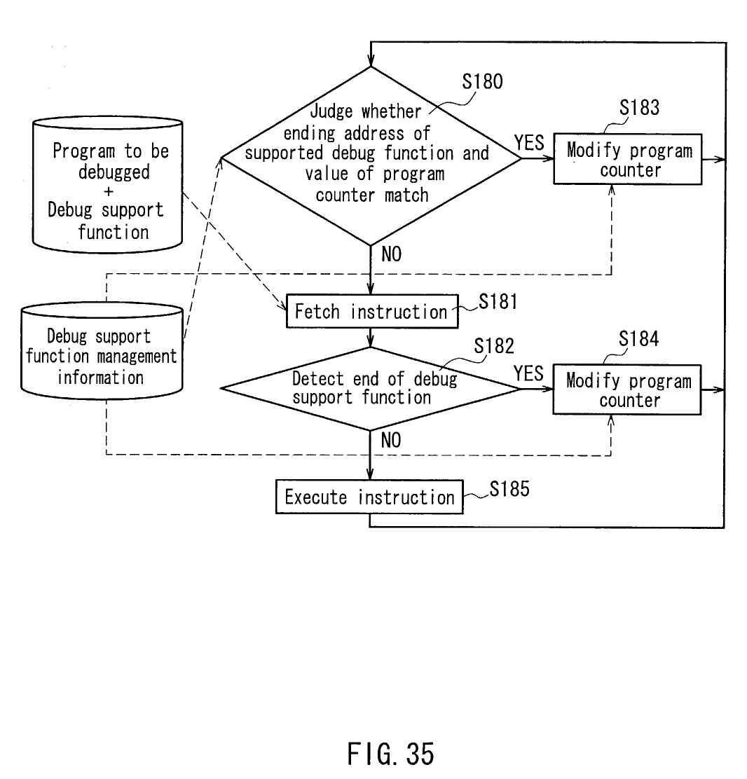

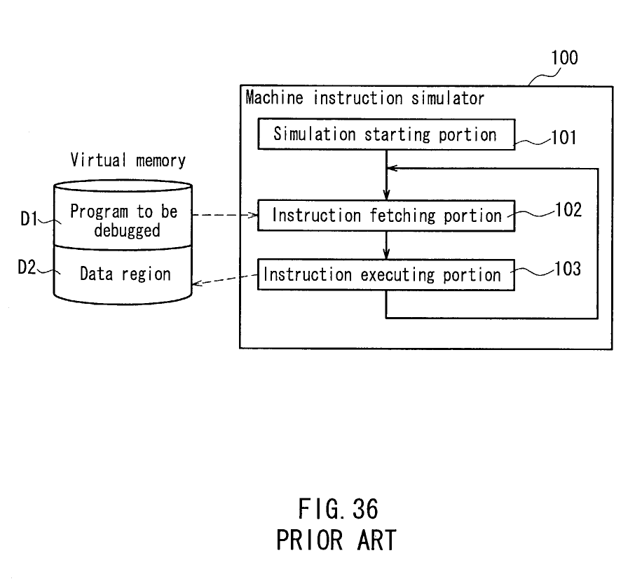

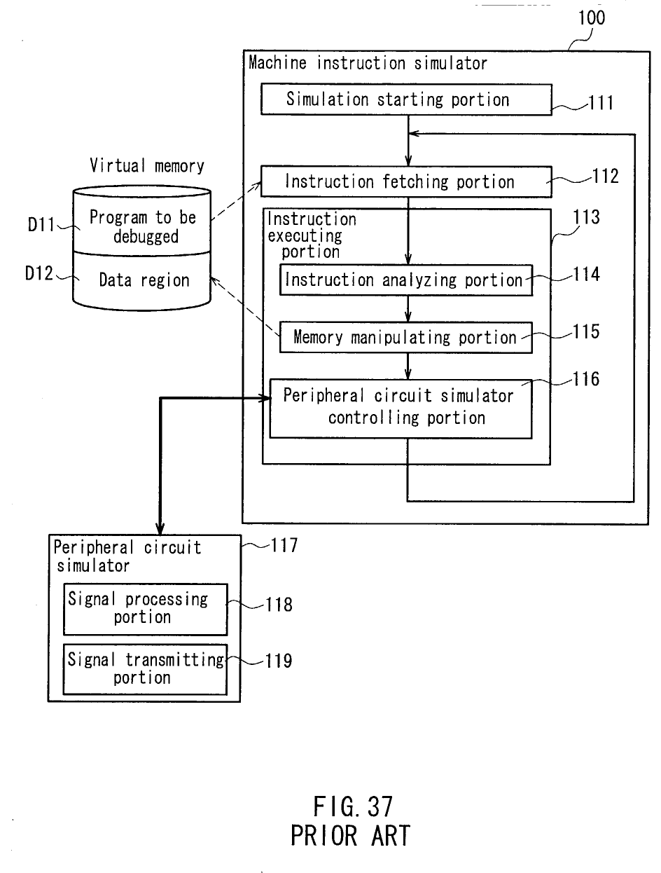

In the present invention, however, it also is possible to compare the ending address of the supported debug function and the value of the program counter in operation S120, thereby executing the debug support function after executing the supported debug function. In this case, the program counter is set to indicate the instruction following the invoking of the supported debug function after executing the debug support function. An example thereof will be described below referring to FIG. 35.

FIG. 35 is a flowchart showing another example in the fourth embodiment. The simulation apparatus in the present example also is configured similarly to that described in the fourth embodiment. In this example, operation S190 is different from operation S120 shown in FIG. 13, and the judging portion compares the ending address of the supported debug function and the value of the program counter. If they match, the judging portion modifies the value of the program counter to the starting address of the debug support function (operation S193). The operations S191, S192, S194 and S195 shown in FIG. 35 respectively correspond to operations S121, S122, S124 and S125 that have been illustrated in FIG. 13, and similar operations are carried out.

Fifth Embodiment

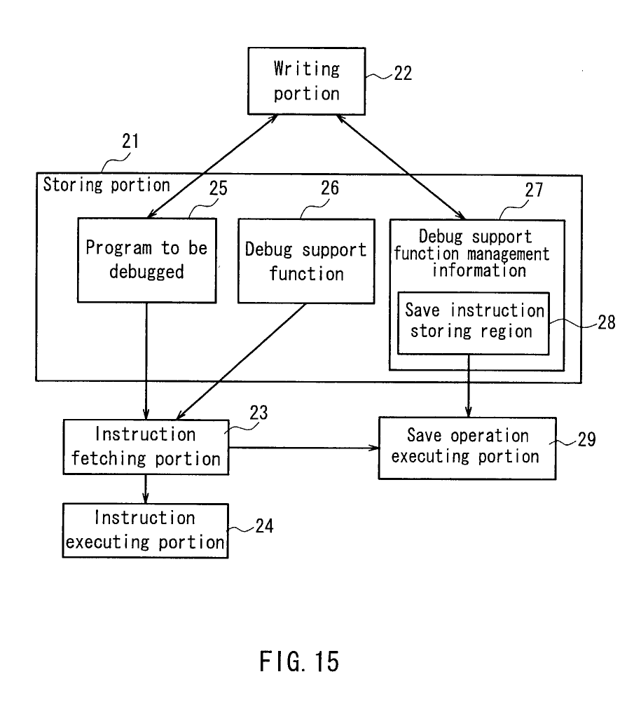

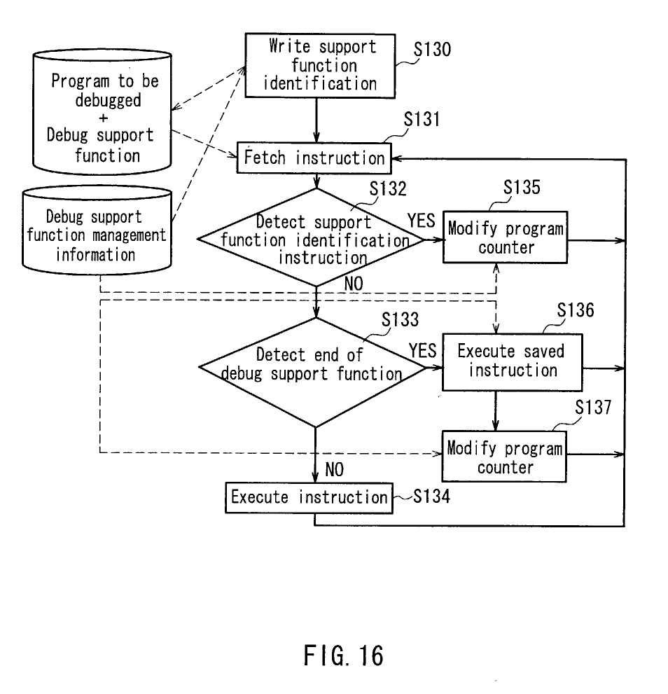

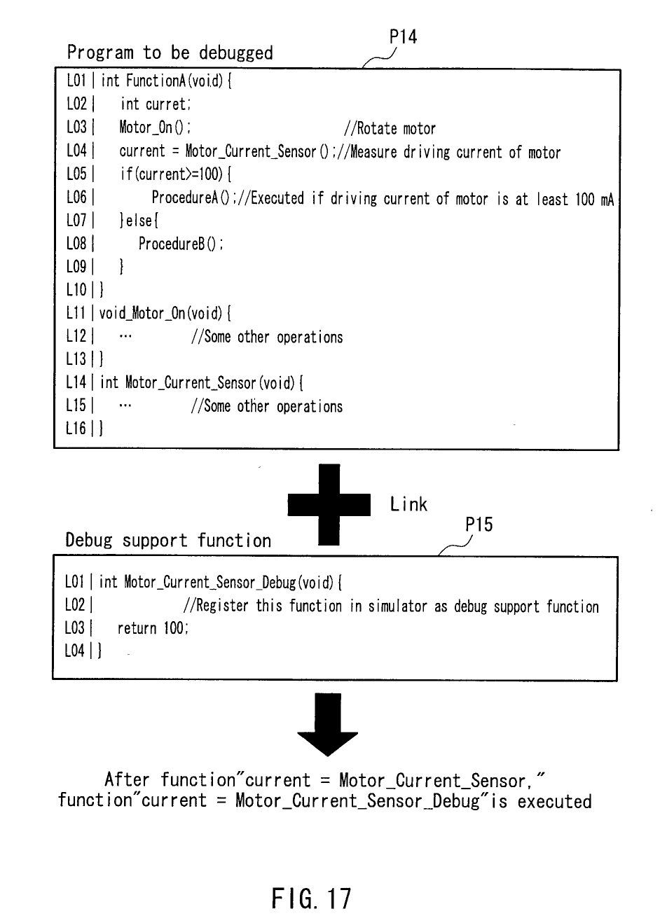

The following is a description of a simulation apparatus and a simulation method according to the fifth embodiment of the present invention, with reference to FIGS. 15 and 17. FIG. 15 shows a configuration of the simulation apparatus according to the fifth embodiment of the present invention. FIG. 16 is a flowchart showing the simulation method and a process flow of the simulation apparatus shown in FIG. 15 according to the fifth embodiment of the present invention.

The simulation apparatus and the simulation method according to the fifth embodiment are similar to those of the first and second embodiments in that an instruction for invoking a debug support function is embedded in a program to be debugged, but are different in that the debug support function is executed after executing a supported debug function.

First, a configuration of the simulation apparatus according to the fifth embodiment will be described referring to FIG. 15. As shown in FIG. 15, the simulation apparatus according to the present embodiment includes a storing portion 21, a writing portion 22, an instruction fetching portion 23, an instruction executing portion 24 and a save operation executing portion 29.

As in the first embodiment, the storing portion 21 also stores a program to be debugged 25, a debug support function 26 for supporting a control operation contained in the program to be debugged 25 and debug support function management information 27 in the present embodiment. The information stored as the debug support function management information 27 also is similar to that in the first embodiment. Furthermore, in a region storing the debug support function management information 27 in the storing portion 21, a save instruction storing region 28 is reserved as in the first embodiment.

FIG. 17 illustrates examples of the program to be debugged and the debug support function used in the fifth embodiment. In a program to be debugged P14 shown in FIG. 17, a supported debug function “int Motor_Current_Sensor (void)” with a line number L14 is supported by “int Motor_Current_Sensor_Debug (void)” with a line number L01 in a debug support function P15. The contents of the program to be debugged P14 and the debug support function P15 shown in FIG. 17 are the same as those of the program to be debugged P10 and the debug support function P11 shown in FIG. 3.

As in the above-described embodiments, the simulation apparatus according to the fifth embodiment also is realized by installing a program on a computer. This program realizes a simulation method, which will be described below referring to FIG. 16.

Now, referring to FIG. 16, the simulation method and an operation in each portion in the simulation apparatus shown in FIG. 15 will be described according to the fifth embodiment. The description accompanies suitable references to FIG. 15 because the simulation method shown in FIG. 16 also is carried out by running the simulation apparatus shown in FIG. 15 in the present embodiment.

First, the program to be debugged, the debug support function and a value of an ending address of the debug support function are obtained. In the present embodiment, they also have been obtained already by the storing portion 21 as shown in FIG. 15. Thus, this operation also is omitted in FIG. 16.

Then, as shown in FIG. 16, the writing portion 22 writes into the program to be debugged 25 a support function identification instruction for invoking the debug support function instead of an ending instruction of the supported debug function (operation S130). Referring to FIG. 17, the writing portion 22 rewrites the ending instruction of the supported debug function “Motor_Current_Sensor ( )” in the program to be debugged P14 to the support function identification instruction based on the debug support function management information 27.

At this time, the writing portion 22 further saves the ending instruction of the supported debug function in a region other than the region storing the program to be debugged 25 in the storing portion 21, which is, in the fifth embodiment, a region reserved in the debug support function management information 27.

Next, the instruction fetching portion 23 fetches an instruction from the program to be debugged (operation S131) and judges whether the fetched instruction is the support function identification instruction written in operation S130 (operation S132).

If it is the support function identification instruction, the instruction fetching portion 23 modifies the program counter (operation S135). In this manner, the debug support function 26 is executed.

More specifically, the instruction fetching portion 23 modifies the current program counter to a preceding address of the debug support function P15 “Motor_Current_Sensor_Debug ()” shown in FIG. 17 corresponding to the supported debug function, based on the debug support function management information.

If it is not, the save operation executing portion 29 judges whether the value of the program counter matches the value of the ending address of the debug support function 26 (operation S133).

If the value of the program counter and the value of the ending address of the debug support function 26 match, the save operation executing portion 29 executes the ending instruction of the supported debug function that has been saved in operation S130 (operation S136). Thereafter, the save operation executing portion 29 modifies the program counter to an address after executing the ending instruction of the supported debug function (operation S137).

If they do not match, the instruction executing portion 24 executes the instruction fetched from the program to be debugged 25 or the debug support function 26 (operation S134). The instruction executing portion 24 performs modification of the program counter, writing into the storing portion 21, reading out from the storing portion 21 and calculation, based on the fetched instruction. Until the execution of the program to be debugged 25 ends, the operations S130 to S137 described above are executed repeatedly.

As described above, the debug support function can be executed after executing the supported debug function in the fifth embodiment. Thus, according to the fifth embodiment, it is easy to modify a return value alone in the supported debug function, making it possible to control an operation path of the program to be debugged by modifying the debug support function instead of the program to be debugged.

As described above, in the fifth embodiment, the ending instruction of the supported debug function is rewritten to the identification instruction, thereby executing the debug support function after executing the supported debug function.

In the present invention, however, it also is possible to rewrite a staring instruction of the supported debug function to the identification instruction in the operation S130, thereby executing the supported debug function after executing the debug support function.

Sixth Embodiment

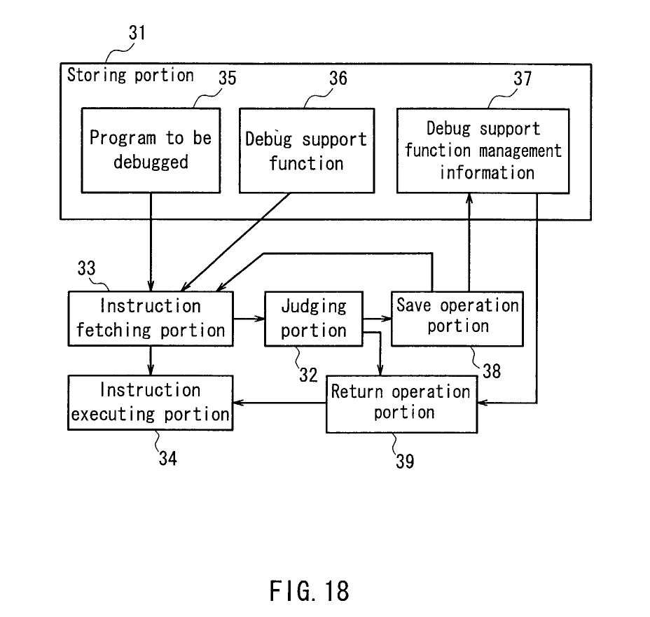

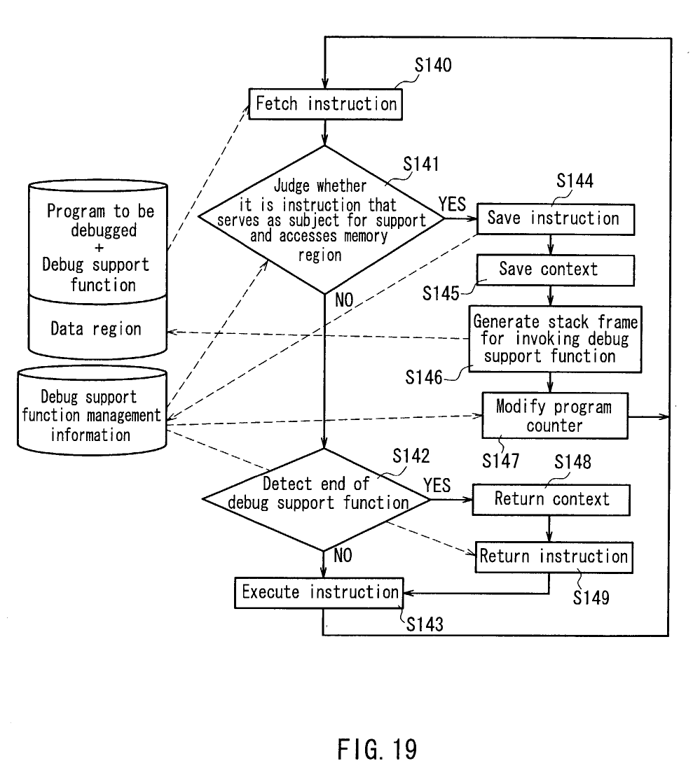

The following is a description of a simulation apparatus and a simulation method according to the sixth embodiment of the present invention, with reference to FIGS. 18 to 21. FIG. 18 shows a configuration of the simulation apparatus according to the sixth embodiment of the present invention. FIG. 19 is a flowchart showing the simulation method and a process flow of the simulation apparatus shown in FIG. 18 according to the sixth embodiment of the present invention.

The simulation apparatus and the simulation method according to the sixth embodiment execute a debug support function before an access (a read access, in particular) to a memory region by a control operation in the program to be debugged. In the present embodiment, the debug support function supports an instruction for performing the control operation in the program to be debugged and accessing the memory region.

First, a configuration of the simulation apparatus according to the sixth embodiment will be described referring to FIG. 18. As shown in FIG. 18, the simulation apparatus according to the present embodiment includes a storing portion 31, an instruction fetching portion 33, an instruction executing portion 34, a judging portion 32, a save operation portion 38 and a return operation portion 39.

As in the first embodiment, the storing portion 31 stores a program to be debugged 35, a debug support function 36 and debug support function management information 37 in the present embodiment. However, the content of the debug support function management information is different from that in the first embodiment.

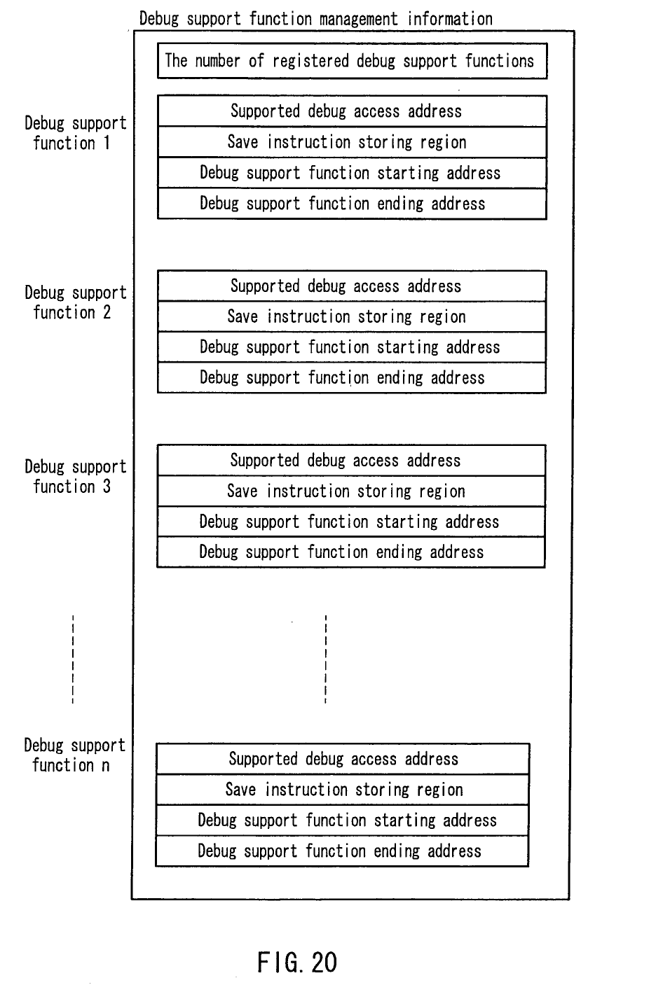

FIG. 20 illustrates the debug support function management information in the sixth embodiment. As shown in FIG. 20, in the sixth embodiment, the storing portion 31 stores the number of registered debug support functions, a debug support function starting address and a debug support function ending address, as the debug support function management information 37 as in the first embodiment, while it further stores a supported debug access address in the present embodiment. Here, the supported debug access address refers to a memory address where the instruction of the supported debug function for accessing a memory region access operations. Furthermore, in a region storing the debug support function management information 37 in the storing portion 31, a save instruction storing region is reserved as in the first embodiment.

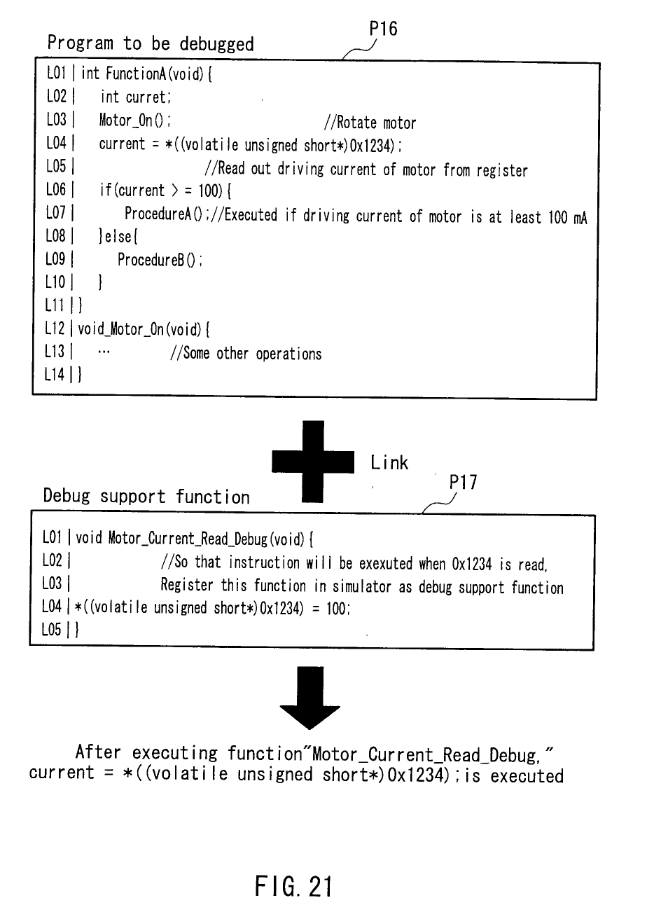

FIG. 21 illustrates examples of the program to be debugged and the debug support function used in the sixth embodiment. As shown in FIG. 21, a program to be debugged P16 is supported by a debug support function P17. More specifically, before a read access to “0×1234” in a supported debug function with a line number L04 in the program to be debugged P16, a debug support function “Motor_Current_Read_Debug ( )” is executed, followed by the read access to “0×1234”.

As in the above-described embodiments, the simulation apparatus according to the sixth embodiment also is realized by installing a program on a computer. This program realizes a simulation method, which will be described below referring to FIG. 19.

Now, referring to FIG. 19, the simulation method and an operation in each portion in the simulation apparatus shown in FIG. 18 will be described according to the sixth embodiment. The description accompanies suitable references to FIG. 18 because the simulation method shown in FIG. 19 also is carried out by running the simulation apparatus shown in FIG. 18 in the present embodiment.

First, the program to be debugged, the debug support function and the debug support function management information are obtained. In the present embodiment, they also have been obtained already by the storing portion 31 as shown in FIG. 18. Thus, this operation also is omitted in FIG. 19.

Next, as shown in FIG. 19, the instruction fetching portion 33 fetches an instruction of the program to be debugged from the storing portion 31 based on a program counter (operation S140).

Furthermore, the judging portion 32 judges whether the fetched instruction is an instruction that serves as a subject for support by the debug support function 36 and accesses the memory region, based on the supported debug access address stored as the debug support function management information 37 (operation S141).

In the present embodiment, the access to the memory region refers to the reading out and writing in data with respect to all of address spaces that the program to be debugged can access, and the address spaces here include not only a memory address space but also an I/O address space. Furthermore, the memory may be replaced with a resource such as a general purpose resister.

If the fetched instruction is an instruction for accessing the memory region serving as the subject for support, the save operation portion 38 saves the fetched instruction (operation S144) and a context (operation S145). More specifically, the save operation portion 38 saves the fetched instruction in the save instruction storing region reserved in the debug support function management information 37. Also, the save operation portion 38 saves as the context, the contents of a program counter, a stack pointer register and a general purpose register that are used currently, in the save instruction storing region.

In this case, the save operation portion 38 also generates a stack frame for invoking the debug support function (operation S146). The stack frame for invoking the debug support function is generated by storing arguments in the region indicated by the stack on the general purpose register, according to the function invoked as the debug support function. Furthermore, the save operation portion 38 modifies the program counter based on the starting address of the debug support function stored as the debug support function management information 37 (operation S147) and makes the instruction fetching portion 33 fetch the instruction from the debug support function 36 (operation S140).

On the other hand, if the fetched instruction is not the instruction for accessing the memory region serving as the subject for support, the return operation portion 39 judges whether it is the ending instruction of the debug support function 36 based on the debug support function management information 37 (operation S142). If it is the ending instruction of the debug support function 36, the return operation portion 39 returns the value of the general purpose register, the stack pointer, the program counter etc. that have been saved in operation S145, thus performing a return operation of the context (operation S148). Furthermore, the return operation of the instruction saved in operation S144 also is carried out (operation S149).

If it is not, the instruction executing portion 34 executes the instruction fetched from the program to be debugged 35 or the debug support function 36 (operation S143). The instruction executing portion 34 performs modification of the program counter, writing into the storing portion 31, reading out from the storing portion 31 and calculation, based on the fetched instruction. Until the execution of the program to be debugged 35 ends, the operations S140 to S149 described above are executed repeatedly.

As described above, the debug support function is executed at the time of the read access to the memory, making it possible to modify directly the content to be read out from the memory at the time of reading in the sixth embodiment. Thus, when an execution path of a program is modified by the data read out from the memory, the execution path can be designated indirectly by the present embodiment.

Seventh Embodiment

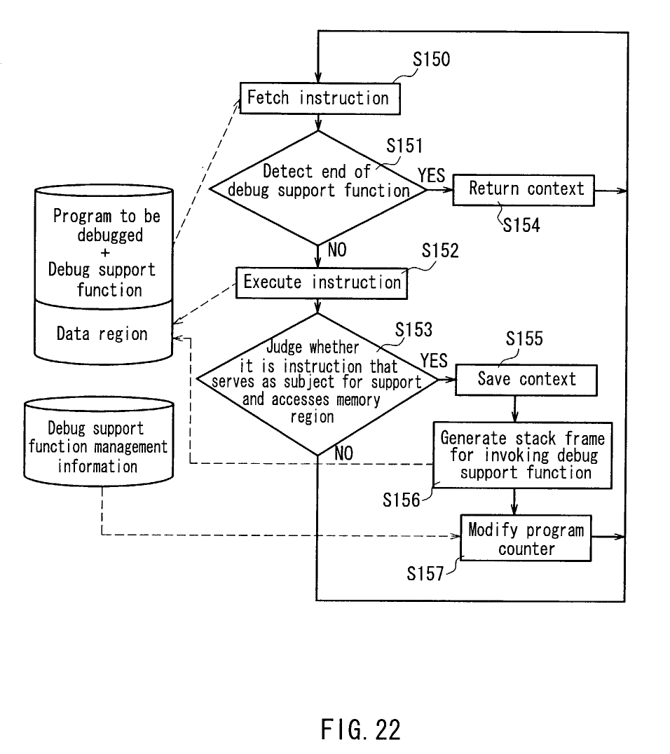

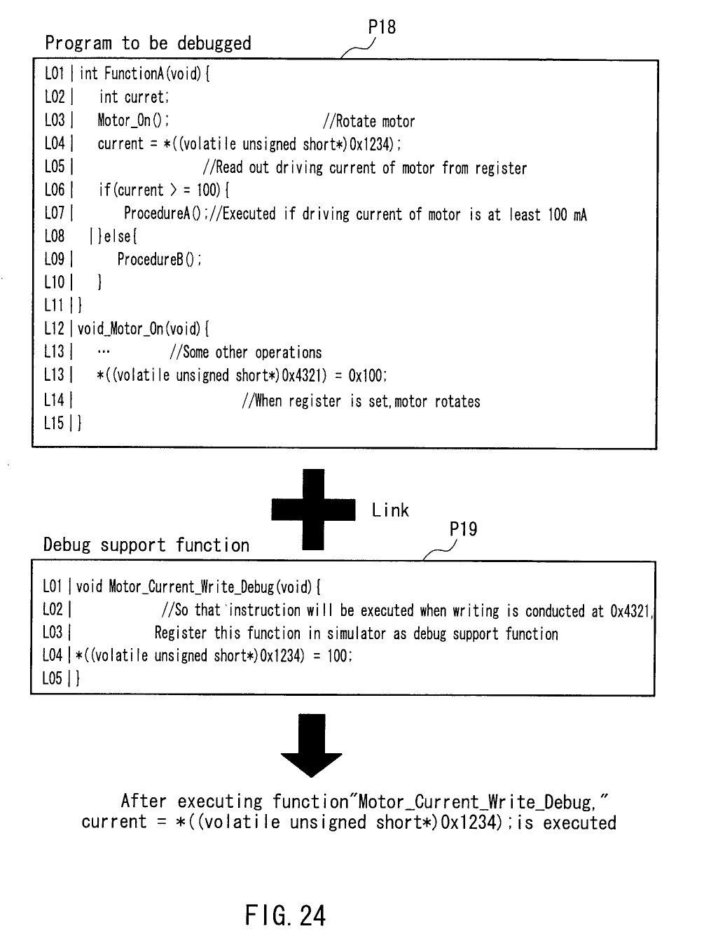

The following is a description of a simulation apparatus and a simulation method according to the seventh embodiment of the present invention, with reference to FIGS. 22 and 24. FIG. 22 is a flowchart showing the simulation method and a process flow of the simulation apparatus according to the seventh embodiment of the present invention.

Unlike the sixth embodiment, the simulation apparatus and the simulation method according to the seventh embodiment execute a debug support function after an access (a write access, in particular) to a memory region by a control operation in the program to be debugged. In the present embodiment, the debug support function also supports an instruction for performing the control operation in the program to be debugged and accessing the memory region.

First, the simulation apparatus according to the seventh embodiment will be described. As in the simulation apparatus shown in the sixth embodiment, the simulation apparatus according to the present embodiment includes a storing portion, an instruction fetching portion, a judging portion, a save operation portion and a return operation portion. However, the present embodiment is different from the sixth embodiment in the operations in the judging portion, the save operation portion and the return operation portion. Moreover, the content of debug support function management information is different from that of the sixth embodiment.

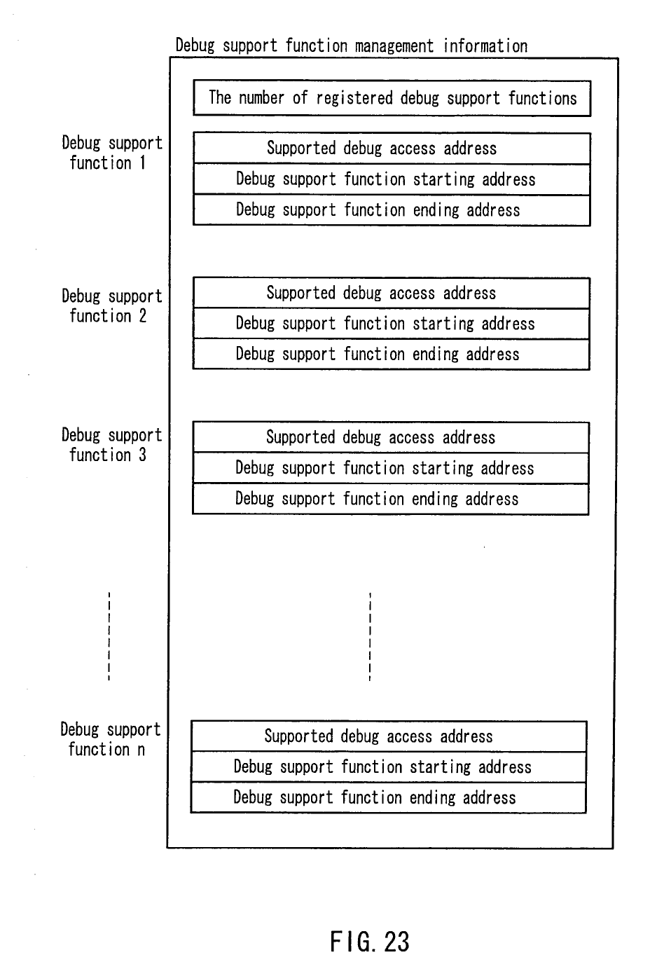

FIG. 23 illustrates the debug support function management information in the seventh embodiment. As shown in FIG. 23, as in the sixth embodiment, the storing portion also stores the number of registered debug support functions, a supported debug access address, a debug support function starting address and a debug support function ending address, as the debug support function management information, in the seventh embodiment.

FIG. 24 illustrates examples of the program to be debugged and the debug support function used in the seventh embodiment. As shown in FIG. 24, a program to be debugged P18 is supported by a debug support function P19. More specifically, after a write access to “0×1234” in a supported debug function with a line number L04 in the program to be debugged P18, a debug support function “Motor_Current_Write_Debug ( )” is executed.

As in the above-described embodiments, the simulation apparatus according to the seventh embodiment also is realized by installing a program on a computer. This program realizes a simulation method, which will be described below referring to FIG. 22.

Now, referring to FIG. 22, the simulation method and an operation in each portion in the simulation apparatus will be described according to the seventh embodiment. First, the program to be debugged, the debug support function and the debug support function management information are obtained. In the present embodiment, they also have been obtained already by the storing portion. Thus, this operation also is omitted in FIG. 22.

Next, as shown in FIG. 22, the instruction fetching portion fetches an instruction from the program to be debugged based on a program counter (operation S150). The fetching of the instruction from the debug support function and the detection of the ending of the debug support function (operation S151) will be described later.

The instruction executing portion executes the instruction fetched from the program to be debugged (operation S152). The instruction executing portion performs modification of the program counter, writing into the storing portion, reading out from the storing portion and calculation, based on the fetched instruction.

Thereafter, the judging portion judges whether the instruction executed in operation S152 is an instruction that serves as the subject for support and accesses the memory region, based on the supported debug access address (operation S153).

In the present embodiment, the access to the memory region also refers to the reading out and writing in data with respect to all of address spaces that the program to be debugged can access, and the address spaces here include not only a memory address space but also an I/O address space. Furthermore, the memory may be replaced with a resource such as a general purpose resister.

If the judging portion does not judge that it is the instruction serving as the subject for support, the instruction fetching portion fetches the next instruction from the program to be debugged (operation S150).

On the other hand, if the judging portion judges that it is the instruction serving as the subject for support, the save operation portion saves a context (operation S155). More specifically, the save operation portion saves the contents of a program counter, a stack pointer register and a general purpose register that are used currently, in an arbitrary region in the storing portion.

In this case, the save operation portion also generates a stack frame for invoking the debug support function (operation S156). The stack frame is generated by storing arguments in the region indicated by the stack on the general purpose register, according to the function invoked as the debug support function.

Furthermore, the save operation portion modifies the program counter based on the starting address of the debug support function stored as the debug support function management information (operation S157) and makes the instruction fetching portion fetch the instruction from the debug support function (operation S150).

The return operation portion judges whether the instruction fetched from the debug support function is the ending instruction of the debug support function, based on the debug support function management information 37 (see FIG. 18) (operation S151). If it is not the ending instruction of the debug support function, the instruction executing portion executes this instruction (operation S152).

On the other hand, if it is the ending instruction of the debug support function, the return operation portion returns the value of the general purpose register, the stack pointer, the program counter etc. that have been saved in operation S155, thus performing a return operation of the context (operation S154). Until the execution of the program to be debugged ends, the operations S150 to S157 described above are executed repeatedly.

As described above, the debug support function can be executed after the write access to the memory in the seventh embodiment. Consequently, after modifying the content of the register, it is possible to carry out a certain operation such as an operation of replacing the modified content in the register with another value by the debug support function, for example, and obtain an effect of controlling an execution path of a program easily after accessing a register.

Eighth Embodiment

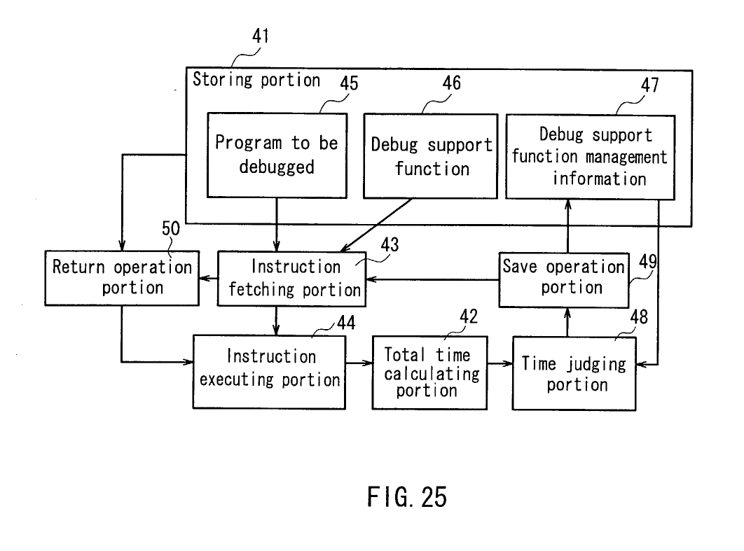

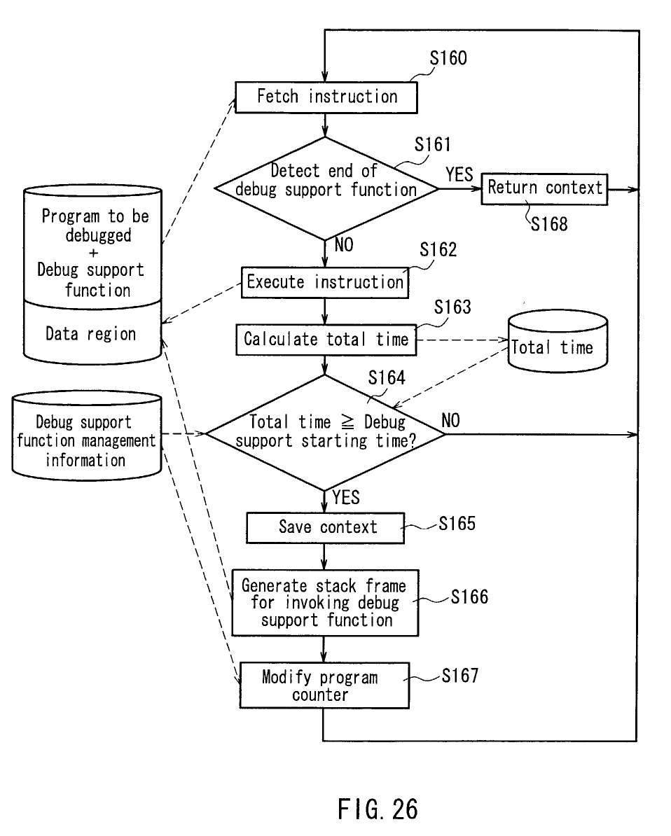

The following is a description of a simulation apparatus and a simulation method according to the eighth embodiment of the present invention, with reference to FIGS. 25 to 28. FIG. 25 shows a configuration of the simulation apparatus according to the eighth embodiment of the present invention. FIG. 26 is a flowchart showing the simulation method and a process flow of the simulation apparatus shown in FIG. 25 according to the eighth embodiment of the present invention.

The simulation apparatus and the simulation method according to the eighth embodiment set in advance an execution starting time for each debug support function (referred to as “a debug support starting time” in the following) based on a time when an execution of a program to be debugged starts, and execute an instruction of the debug support function based on that execution starting time.

First, a configuration of the simulation apparatus according to the eighth embodiment will be described referring to FIG. 25. As shown in FIG. 25, the simulation apparatus according to the present embodiment includes a storing portion 41, an instruction fetching portion 43, an instruction executing portion 44, a total time calculating portion 42, a time judging portion 48, a save operation portion 49 and a return operation portion 50.

As in the first embodiment, the storing portion 41 also stores a program to be debugged 45, a debug support function 46 for supporting a control operation in the program to be debugged 45 and debug support function management information 47 in the present embodiment. However, the content of the debug support function management information is different from that in the first embodiment.

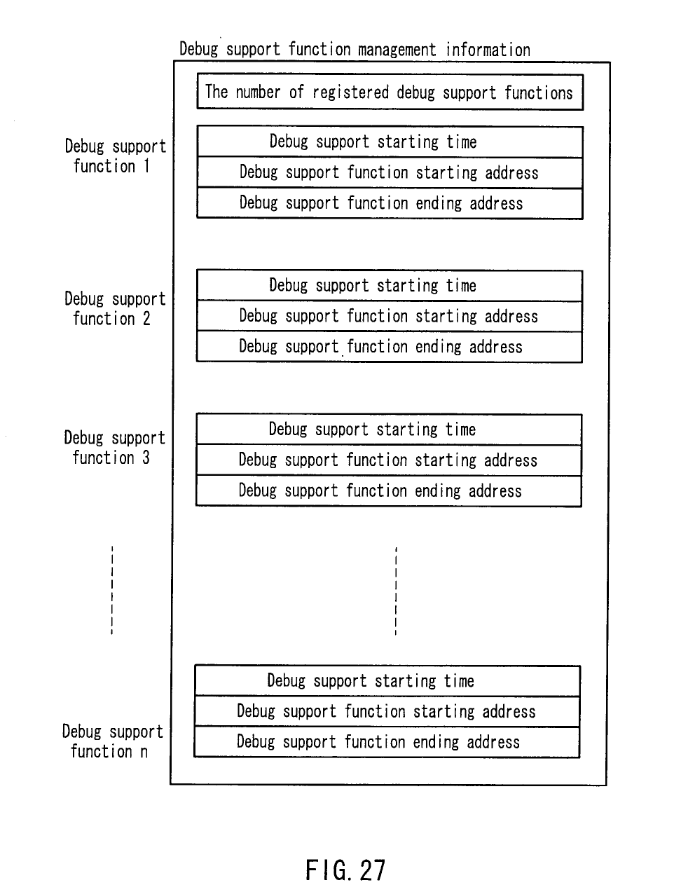

FIG. 27 illustrates the debug support function management information in the eighth embodiment. As shown in FIG. 27, as in the first embodiment, the storing portion 41 also stores the number of registered debug support functions, a debug support function starting address and a debug support function ending address, as the debug support function management information 47 in the eighth embodiment. However, it also stores a debug support starting time that has been set in advance for each supported debug function in the present embodiment.

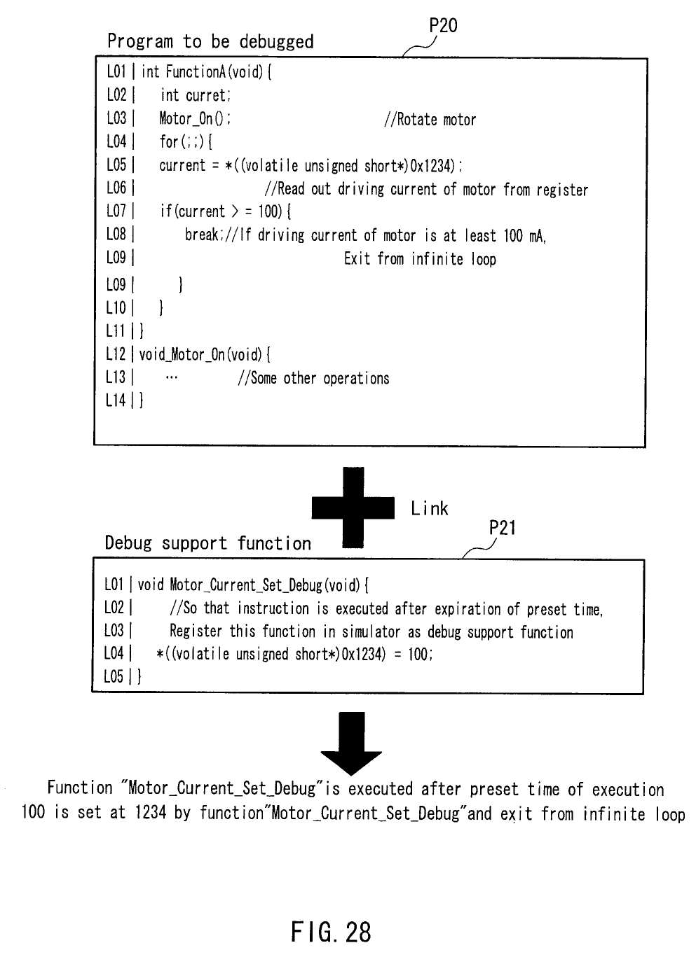

FIG. 28 illustrates examples of the program to be debugged and the debug support function used in the eighth embodiment. As shown in FIG. 28, a program to be debugged P20 is supported by a debug support function P21. The debug support function P21 is executed instead of the program to be debugged P20 after the expiration of the preset execution starting time.

As in the above-described embodiments, the simulation apparatus according to the eighth embodiment also is realized by installing a program on a general purpose computer. This program realizes a simulation method, which will be described below referring to FIG. 26.

Now, referring to FIG. 26, the simulation method and an operation in each portion in the simulation apparatus shown in FIG. 25 will be described according to the eighth embodiment. The description accompanies suitable references to FIG. 25 because the simulation method shown in FIG. 26 also is carried out by running the simulation apparatus shown in FIG. 25 in the present embodiment.

First, the program to be debugged 45, the debug support function 46 and the debug support function management information 47 are obtained. In the present embodiment, they also have been obtained already by the storing portion 41 as shown in FIG. 25. Thus, this operation also is omitted in FIG. 26.

Next, as shown in FIG. 26, the instruction fetching portion 43 fetches an instruction from the program to be debugged 45 based on a program counter (operation S160). The fetching of the instruction from the debug support function and the detection of the ending of the debug support function (operation S161) will be described later.

Then, the instruction executing portion 44 executes the instruction fetched from the program to be debugged 47 (operation S162). The instruction executing portion 44 performs modification of the program counter, writing into the storing portion 41, reading out from the storing portion 41 and calculation, based on the fetched instruction.

Subsequently, the total time calculating portion 42 calculates the total time from the start of the program to be debugged to the end of the execution of the instruction of operation S162 (operation S163). More specifically, the total time calculating portion 42 performs this calculation by adding the time required for operation S162 to the total time before operation S162. The calculated total time is stored in an arbitrary region in the storing portion.

Thereafter, the time judging portion 48 judges whether the value of the total time calculated in operation S163 is equal to or larger than the value of the debug support starting time stored as the debug support function management information 47 and checks further whether no debug support function is executed at present (operation S164).

If the time judging portion 48 does not judge that the value of the total time is equal to or larger than the value of the debug support starting time, the instruction fetching portion fetches the next instruction from the program to be debugged (operation S160).

On the other hand, if the time judging portion 48 judges that it is equal to or larger than the value of the debug support starting time and no debug support function is executed at present, the save operation portion 49 saves a context (operation S165). More specifically, the save operation portion 49 saves the contents of a program counter, a stack pointer register and a general purpose register that are used currently, in an arbitrary region in the storing portion 41.

In this case, the save operation portion 49 also generates a stack frame for invoking the debug support function (operation S166). The stack frame is generated by storing arguments in the region indicated by the stack on the general purpose register, according to the function invoked as the debug support function 46.

Furthermore, the save operation portion 49 modifies the program counter based on the starting address of the debug support function 46 stored as the debug support function management information 47 (operation S167) and makes the instruction fetching portion 43 fetch the instruction from the debug support function 46 (operation S160).

The return operation portion 50 judges whether the instruction fetched from the debug support function 46 is the ending instruction of the debug support function, based on the debug support function management information 47 (operation S161). If it is not the ending instruction of the debug support function, the instruction executing portion 44 executes this instruction (operation S162).

On the other hand, if it is the ending instruction of the debug support function, the return operation portion 50 returns the value of the general purpose register, the stack pointer, the program counter etc. that have been saved in operation S165, thus performing a return operation of the context (operation S168). Until the execution of the program to be debugged 45 ends, the operations S160 to S168 described above are executed repeatedly.

As described above, the debug support function is executed at a predetermined time in the eighth embodiment. Consequently, an operation such as a periodical communication interrupt can be realized easily by the debug support function. By changing the execution path of the program over time, it becomes possible to perform simulation that is more similar to the operation of the final product. This can produce an effect of expanding a debug range and enhancing debug efficiency.

Ninth Embodiment

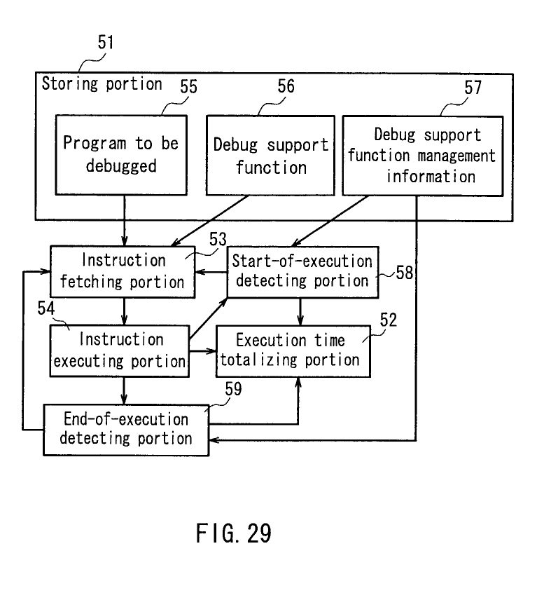

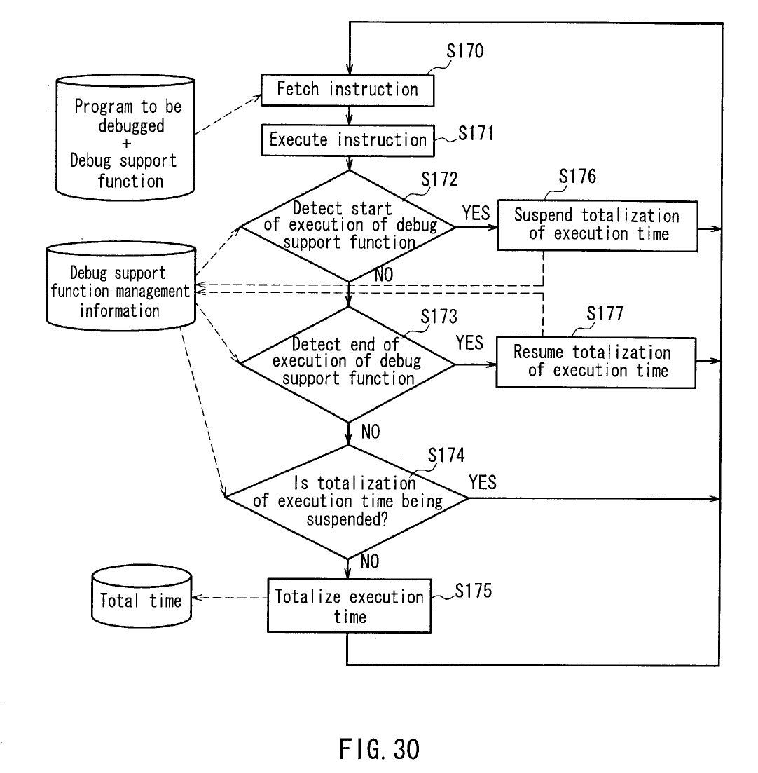

The following is a description of a simulation apparatus and a simulation method according to the ninth embodiment of the present invention, with reference to FIGS. 29 to 31. FIG. 29 shows a configuration of the simulation apparatus according to the ninth embodiment of the present invention. FIG. 30 is a flowchart showing the simulation method and a process flow of the simulation apparatus shown in FIG. 29 according to the ninth embodiment of the present invention.

The simulation apparatus and the simulation method according to the ninth embodiment calculate the time required for executing a program to be debugged, and they are characterized in that the time required for executing a debug support function is not calculated into that time.

First, a configuration of the simulation apparatus according to the ninth embodiment will be described referring to FIG. 29. As shown in FIG. 29, the simulation apparatus according to the present embodiment includes a storing portion 51, an instruction fetching portion 53, an instruction executing portion 54, an execution time totalling portion 52, a start-of-execution detecting portion 58 and an end-of-execution detecting portion 59.

As in the first embodiment, the storing portion 51 also stores a program to be debugged 55, a debug support function 56 for supporting a control operation in the program to be debugged 55 and debug support function management information 57 in the present embodiment. However, in the present embodiment, it stores the number of registered debug support functions, a debug support function starting address and a debug support function ending address, as the debug support function management information 57 and further, if necessary, a supported debug function starting address and a supported debug function ending address, or a supported debug access address and a debug support starting time. Examples of the program to be debugged and the debug support function in the ninth embodiment can be those shown in FIGS. 3, 14, 17, 21, 24 and 28 described above.

As in the above-described embodiments, the simulation apparatus according to the ninth embodiment also is realized by installing a program on a general purpose computer. This program realizes a simulation method, which will be described below referring to FIG. 30.

Now, referring to FIG. 30, the simulation method and an operation in each portion in the simulation apparatus shown in FIG. 29 will be described according to the ninth embodiment. The description accompanies suitable references to FIG. 29 because the simulation method shown in FIG. 30 also is carried out by running the simulation apparatus shown in FIG. 29 in the present embodiment.

First, the program to be debugged 55, the debug support function 56 and the debug support function management information 57 are obtained. In the present embodiment, they also have been obtained already by the storing portion 51 as shown in FIG. 29. Thus, this operation also is omitted in FIG. 30.

Next, the instruction fetching portion 53 fetches an instruction from the program to be debugged 55 (operation S170). The instruction fetched from the program to be debugged 55 is executed by the instruction executing portion 54 (operation S171). The instruction executing portion 54 performs modification of the program counter, writing into the storing portion 51, reading out from the storing portion 51 and calculation, based on the fetched instruction. The execution time totalling portion 52 totalizes the execution time from the start of operation S170. This will be described later.

Next, the start-of-execution detecting portion 58 detects the start of the execution of the debug support function 56 (operation S172). More specifically, the start-of-execution detecting portion 58 detects the start of the execution of the debug support function 56 by comparing the debug support function starting address and the program counter that are stored as the debug support function management information.

When the start of the execution of the debug support function 56 is detected, the start-of-execution detecting portion 58 makes the execution time totalling portion 52 suspend the totalization of the execution time (operation S176), makes the instruction fetching portion 53 fetch the instruction from the debug support function 56 (operation S170) and makes the instruction executing portion 54 execute the fetched instruction (operation S171).

When the start of the execution of the debug support function 56 is not detected, the end-of-execution detecting portion 59 detects the end of the execution of the debug support function 56 (operation S173). More specifically, the debug support function ending address and the program counter that are stored in the storing portion 51 as the debug support function management information 57 are compared, and a judgment is made according to whether they match.

When the end of the execution of the debug support function 56 is detected, the end-of-execution detecting portion 59 makes the execution time totalling portion 52 resume the totalization of the execution time (operation S177). Thereafter, the operations S170 to S173 are carried out.

Then, the execution time totalling portion 52 confirms that the totalization of the execution time is resumed (operation S174), and the value of the totalized execution time is stored in an arbitrary region in the storing portion 51 (operation S175). More specifically, the execution time totalling portion 52 adds the time required for the execution of operation S171 to the execution time before the start of operation S170 that already has been stored in the storing portion 51.

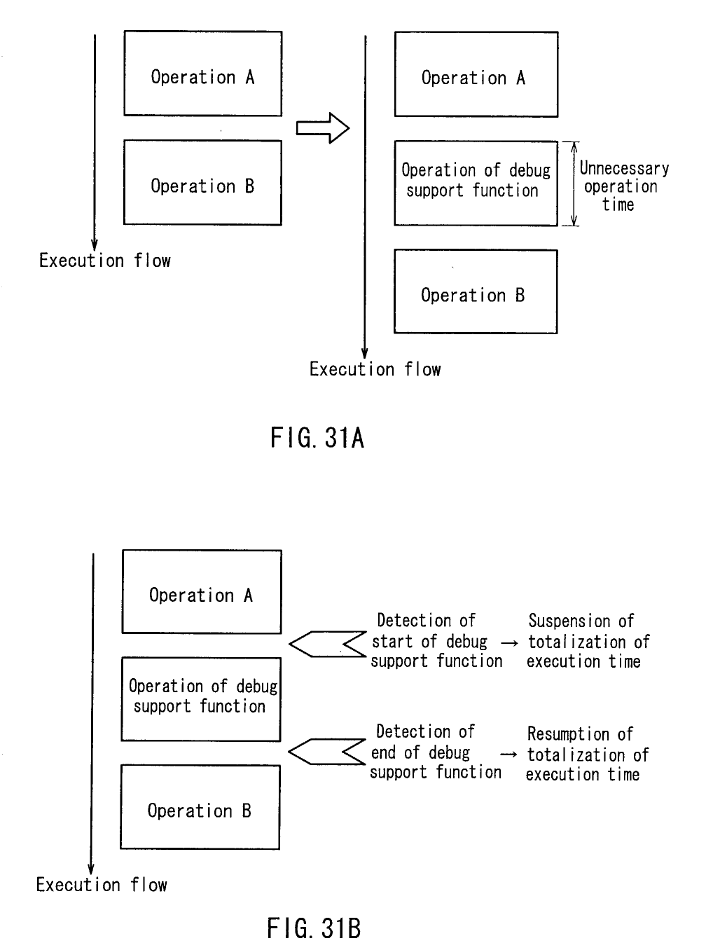

Until the execution of the program to be debugged 55 ends, the operations S170 to S177 described above are executed repeatedly. FIG. 31 schematically shows the suspension and resumption of the totalization of the execution time by operations S170 to S177 described above. FIG. 31A shows how the time required for executing from start to end a program to be debugged becomes longer in the case where a debug support function is executed. FIG. 31B shows how the time required for executing the debug support function is not calculated into a total time in the present embodiment.

As described above, in the ninth embodiment, the totalization of the execution time is suspended from the start to end of the execution of the debug support function. This makes it possible to produce an effect that the time required for the simulation of the program to be debugged alone except the time required for executing the debug support function can be obtained.

Tenth Embodiment

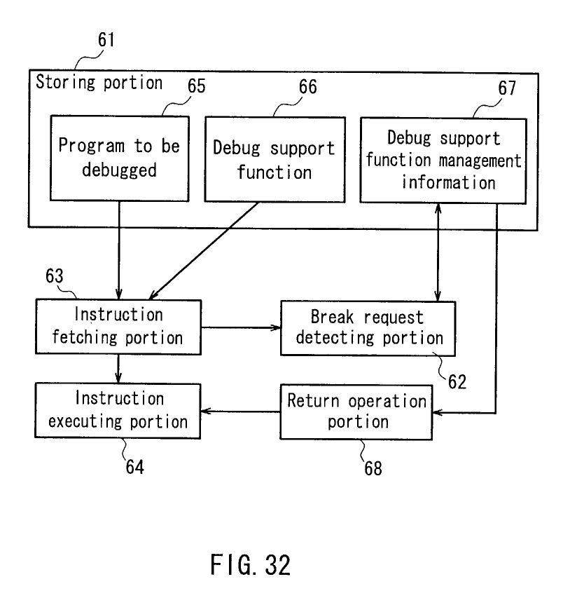

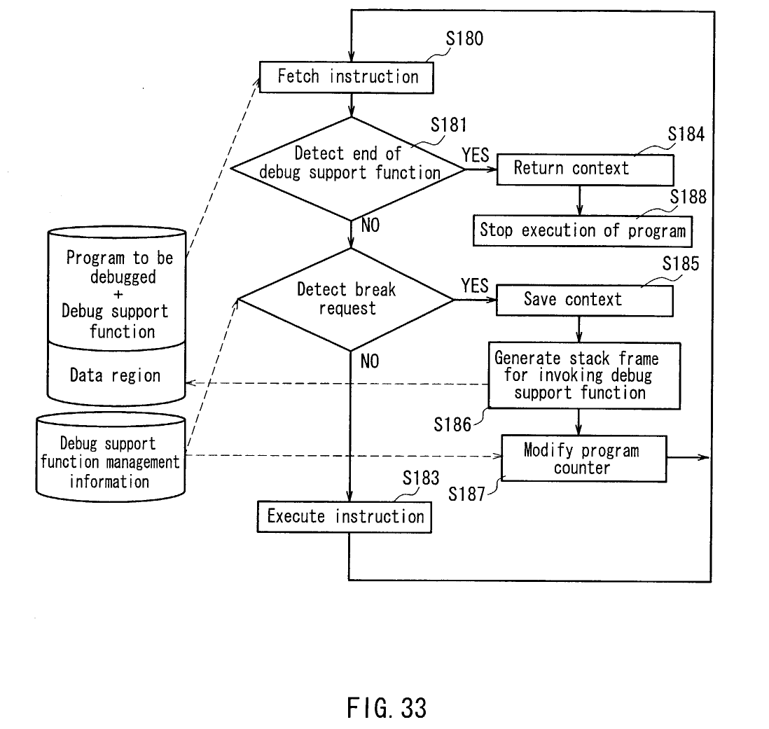

The following is a description of a simulation apparatus and a simulation method according to the tenth embodiment of the present invention, with reference to FIGS. 32 to 33. FIG. 32 shows a configuration of the simulation apparatus according to the tenth embodiment of the present invention. FIG. 33 is a flowchart showing the simulation method and a process flow of the simulation apparatus shown in FIG. 32 according to the tenth embodiment of the present invention.

The simulation apparatus and the simulation method according to the tenth embodiment are characterized in that they execute a debug support function by judging if a break request is present during an execution of a program to be debugged.

First, a configuration of the simulation apparatus according to the tenth embodiment will be described referring to FIG. 32. As shown in FIG. 32, the simulation apparatus according to the present embodiment includes a storing portion 61, an instruction fetching portion 63, an instruction executing portion 64, a break request detecting portion 62 and a return operation portion 68. The break request in the present embodiment is inputted by changing a variable to be a break request flag.

As in the first embodiment, the storing portion 61 also stores a program to be debugged 65, a debug support function 66 for supporting a control operation in the program to be debugged 65 and debug support function management information 67 in the present embodiment. However, in the present embodiment, the number of registered debug support functions, a debug support function starting address, a debug support function ending address and a total time serve as the debug support function management information 67, and further, a supported debug function starting address and a supported debug function ending address, or a supported debug access address and a debug support starting time are stored as necessary. Examples of the program to be debugged and the debug support function in the tenth embodiment can be those shown in FIGS. 3, 14, 17, 21, 24 and 28 described above.

As in the above-described embodiments, the simulation apparatus according to the tenth embodiment also is realized by installing a program on a general purpose computer. This program realizes a simulation method, which will be described below referring to FIG. 33.

Now, referring to FIG. 33, the simulation method and an operation in each portion in the simulation apparatus shown in FIG. 32 will be described according to the tenth embodiment. The description accompanies suitable references to FIG. 32 because the simulation method shown in FIG. 33 also is carried out by running the simulation apparatus shown in FIG. 32 in the present embodiment.

First, the program to be debugged 65, the debug support function 66 and the debug support function management information 67 are obtained. In the present embodiment, they also have been obtained already by the storing portion 61 as shown in FIG. 32. Thus, this operation also is omitted in FIG. 33.

Next, as shown in FIG. 33, the instruction fetching portion 63 fetches an instruction from the program to be debugged 65 (operation S180). The fetching of the instruction from the debug support function and the detection of the end of the debug support function (operation S181) will be described later.

Then, the break request detecting portion 62 detects a break request (operation S182). If no break request is detected, the instruction executing portion 64 executes the instruction of the program to be debugged 65 fetched already in operation S180 (operation S183). The instruction executing portion 64 performs modification of the program counter, writing into the storing portion 61, reading out from the storing portion 61 and calculation, based on the fetched instruction.

On the other hand, if a break request is detected, the break request detecting portion 62 saves a context (operation S185). More specifically, the break request detecting portion 62 saves the contents of a program counter, a stack pointer register and a general purpose register that are used currently, in an arbitrary region in the storing portion 61.

In this case, the break request detecting portion 62 generates a stack frame for invoking the debug support function (operation S186). The stack frame is generated by storing arguments in the region indicated by the stack on the general purpose register, according to the function invoked as the debug support function 66.

Furthermore, the break request detecting portion 62 modifies the program counter based on the starting address of the debug support function 66 stored as the debug support function management information 67 (operation S187) and makes the instruction fetching portion 63 fetch the instruction from the debug support function 66 (operation S180).

Thereafter, the return operation portion 68 judges whether the instruction fetched from the debug support function 66 is the ending instruction of the debug support function (operation S181). More specifically, the debug support function ending address and the program counter that are stored in the storing portion 61 as the debug support function management information 67 are compared, and a judgment is made according to whether they match.

If it is the ending instruction of the debug support function 66, the return operation portion 68 returns the value of the general purpose register, the stack pointer, the program counter etc. that have been saved in operation S185, thus performing a return operation of the context (operation S184). Subsequently, the execution of the program to be debugged 65 is stopped (operation S188).

On the other hand, if it is not, the return operation portion 68 makes the instruction executing portion 64 execute the instruction fetched from the debug support function (operation S183). Until the execution of the program to be debugged 65 ends, the operations S180 to S183 described above are executed repeatedly.

As described above, the debug support function is executed when the input of the break request is detected in the tenth embodiment. Thus, a function associated with debugging such as a function of outputting the content of a virtual memory to a file during a break can be mounted easily.

Eleventh Embodiment

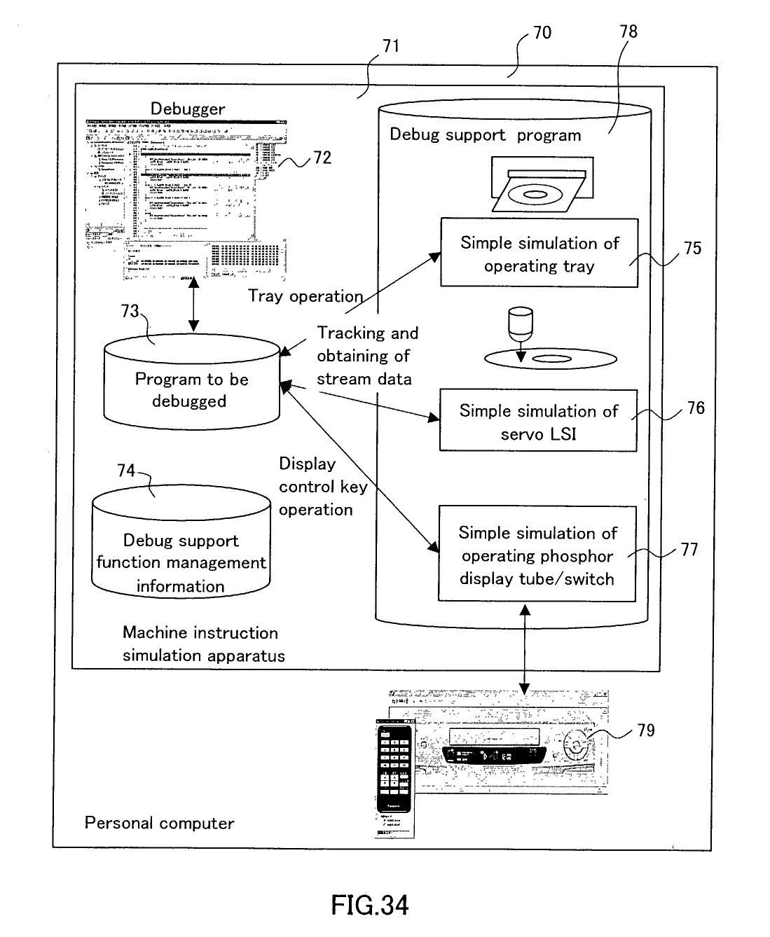

The following is a description of debugging using the simulation apparatus and the simulation method illustrated in the first to tenth embodiments, with reference to FIG. 34. FIG. 34 illustrates an example of debugging using the simulation apparatus and the simulation method according to the present invention. In FIG. 34, a microcomputer program to be incorporated into a DVD player is a subject for debugging.

A simulation apparatus 71 shown in FIG. 34 is realized by installing on a personal computer (or a similar general purpose computer) 70 a simulation program realizing the simulation method of the present invention and executing this program. More specifically, the simulation program is realized by compiling a group of instructions for making a computer execute each of the operations described in the first to tenth embodiments so as to be executable by the personal computer 70, and it is stored in a memory unit (for example, a hard disk or a memory) of the personal computer 70. The program stored in the memory unit of the personal computer 70 is read out by a CPU as necessary, so that the operations described in the first to tenth embodiments are carried out.

The simulation program may be stored in the memory unit of the personal computer 70, for example, by storing the simulation program in a recording medium such as a CD-ROM or a DVD-ROM and reading out this program by a reading device of the personal computer, or by storing the program in a memory unit of another personal computer or a server and reading out this program via a transmission medium.

In FIG. 34, numeral 72 denotes a operating screen of a debugger, which serves as an interface that a debug operator operates. The debugger is stored in the memory unit of the personal computer 70. Numeral 73 denotes a microcomputer program serving as a subject for debugging (a program to be debugged), which is stored in the memory unit of the personal computer 70. Since only a partial operation of simulation can be executed with the debugger 72 and the program to be debugged 73 alone, a debug support program 78 containing a debug support function is stored in the memory unit of the personal computer 70. Numeral 74 denotes debug support function management information, which also is stored in the memory unit of the personal computer 70.

The debug support program 78 includes a program 75 performing a simple simulation of operating a DVD tray, a program 76 performing a simple simulation of servo LSI and a program 77 performing a simple simulation of operating a phosphor display tube/switch.

When the program incorporated in the personal computer 70 is executed, the simulation apparatus 71 associates the program to be debugged 73 and the function of the debug support program 78, further invokes an operation in the program to be debugged 73 as necessary, and changes an execution path in the program to be debugged 73 so as to proceed with debugging, as illustrated in the first to tenth embodiments.

It is possible to improve the reliability and efficiency of debugging when the debug operator can check visually or operate the phosphor display tube and switch, which therefore are linked with a display simulation apparatus 79 in the eleventh embodiment. The display simulation apparatus 79 is realized on the personal computer 70, and a program for executing the display simulation apparatus 79 also is stored in the memory unit of the personal computer 70. Since the program to be debugged 73 is a microcomputer program to be incorporated into a DVD player in the eleventh embodiment, the display simulation apparatus 79, for example, graphically displays an operation of the DVD player that is carried out according to the execution of the program to be debugged 73.

When the debugging is conducted eventually using hardware, the operation in the debug support program 78 does not have to perform a faithful modeling of the hardware. The debug support program 78 is appropriate as long as it can change the execution path of the program to be debugged 73. This still allows for a wide-range debugging. Thus, it is possible to reduce the number of processes for developing the debug support program 78, and consequently further shorten a time period for developing microcomputer programs.

The invention may be embodied in other specific forms without departing from the spirit or essential characteristics thereof. The embodiments disclosed in this application are to be considered in all respects as illustrative and not restrictive, the scope of the invention being indicated by the appended claims rather than by the foregoing description, all changes that come within the meaning and range of equivalency of the claims are intended to be embraced therein.

What is claimed is:

1. A simulation apparatus used for debugging a program containing a control operation of hardware, comprising:
a storing portion that stores at least the program serving as a subject for debugging, a debug support function for supporting a part or a whole of the control operation in the program and a starting address of the control operation serving as a subject for support;
a judging portion for judging whether a value of a program counter indicates the control operation serving as the subject for support based on a value of the starting address and, if it does, modifying the value of the program counter so as to indicate the debug support function;
an instruction fetching portion for fetching an instruction from the program or the debug support function according to the program counter; and
an instruction executing portion for executing the instruction fetched from the program or the debug support function.

2. The simulation apparatus according to claim 1, wherein the storing portion stores an ending address of the control operation serving as the subject for support and a starting address of the debug support function, instead of the starting address of the control operation serving as the subject for support, and
the judging portion judges whether the value of the program counter indicates an ending of the control operation serving as the subject for support based on a value of the ending address and, if it judges that the value of the program counter indicates the ending of the control operation serving as the subject for support, modifies the value of the program counter so as to indicate the debug support function.

3. A simulation apparatus used for debugging a program containing a control operation of hardware, comprising:
a storing portion that stores at least the program serving as a subject for debugging and a debug support function for supporting an instruction that performs the control operation in the program and accesses a memory region;
an instruction fetching portion for fetching an instruction from the program or the debug support function;
a judging portion for judging whether the fetched instruction is an instruction serving as the subject for support;
a save operation portion that saves the fetched instruction and a context and generates a stack frame for invoking the debug support function, and makes the instruction fetching portion fetch the instruction from the debug support function, if the judging portion judges that the fetched instruction is the instruction serving as the subject for support;
a return operation portion for judging whether the fetched instruction is an ending instruction of the debug support function and, if it is, returning the instruction and the context that have been saved; and
an instruction executing portion for executing the instruction fetched from the program or the debug support function.

4. The simulation apparatus according to claim 3, wherein the judging portion judges whether the instruction executed by the instruction executing portion is the instruction serving as the subject for support,
the save operation portion saves the context and generates the stack frame for invoking the debug support function, and makes the instruction fetching portion fetch the instruction from the debug support function, if the judging portion judges that the executed instruction is the instruction serving as the subject for support, and
the return operation portion judges whether the instruction fetched from the debug support function is the ending instruction of the debug support function, returns the context that has been saved if it is and makes the instruction executing portion execute the instruction fetched from the debug support function if it is not.

5. A simulation apparatus used for debugging a program containing a control operation of hardware, comprising:
a storing portion that stores at least the program serving as a subject for debugging, a debug support function for supporting a part or a whole of the control operation in the program and an execution starting time of the debug support function based on a time when an execution of the program starts;
an instruction fetching portion for fetching an instruction from the program or the debug support function;
an instruction executing portion for executing the instruction fetched from the program or the debug support function;
a total time calculating portion for calculating a total time from a start of the program to an end of the execution of the instruction by the instruction executing portion;
a time judging portion for judging whether a value of the total time is equal to or larger than a value of the execution starting time of the debug support function;
a save operation portion that saves a context and generates a stack frame for invoking the debug support function, and makes the instruction fetching portion fetch the instruction from the debug support function, if the time judging portion judges that the value of the total time is equal to or larger than the value of the execution starting time of the debug support function; and
a return operation portion for judging whether the instruction fetched from the debug support function is an ending instruction of the debug support function, returning the context that has been saved if it is and making the instruction executing portion execute the instruction fetched from the debug support function if it is not.

6. A simulation apparatus used for debugging a program containing a control operation of hardware, comprising:
a storing portion that stores at least the program serving as a subject for debugging and a debug support function for supporting a part or a whole of the control operation in the program;
an instruction fetching portion for fetching an instruction from the program or the debug support function;
an instruction executing portion for executing the instruction fetched from the program or the debug support function;
an execution time totalling portion for calculating an execution time from a start of the program;
a start-of-execution detecting portion for detecting a start of an execution of the debug support function, making the execution time totalling portion suspend the totalization of the execution time when the start of the execution is detected, and making the instruction fetching portion fetch the instruction from the debug support function; and
an end-of-execution detecting portion for detecting an end of the execution of the debug support function, making the execution time totalling portion resume the totalization of the execution time when the end of the execution is detected, and making the instruction fetching portion fetch the instruction from the program serving as the subject for debugging.

7. A simulation method used for debugging a program containing a control operation of hardware, comprising:
(a) obtaining a debug support function for supporting a part or a whole of the control operation in the program serving as a subject for debugging and a value of a starting address of the control operation to be supported by the debug support function;
(b) judging whether a value of a program counter indicates the control operation serving as the subject for support based on the obtained value of the starting address;
(c) if it does, modifying the value of the program counter so as to indicate the debug support function;
(d) fetching an instruction from the program or the debug support function according to the program counter; and
(e) executing the instruction fetched from the program or the debug support function.

8. The simulation method according to claim 7, further comprising;
in the (a) obtaining step, obtaining a value of an ending address of the control operation to be supported by the debug support function and a value of a starting address of the debug support function, instead of the value of the starting address of the control operation to be supported by the debug support function,
in the (b) judging step, judging whether the value of the program counter indicates an ending of the control operation serving as the subject for support based on the obtained value of the ending address, and
in the (c) modifying step, if the value of the program counter indicates the ending of the control operation serving as the subject for support, modifying the value of the program counter so as to indicate the debug support function.

9. A simulation method used for debugging a program containing a control operation of hardware, comprising:
(a) obtaining a debug support function for supporting an instruction that performs the control operation in the program serving as a subject for debugging and accesses a memory region;
(b) fetching an instruction from the program;
(c) judging whether the fetched instruction is an instruction serving as the subject for support;
(d) if it is, saving the fetched instruction and a context, generating a stack frame for invoking the debug support function, and fetching an instruction from the debug support function;
(e) judging whether the fetched instruction is an ending instruction of the debug support function;
(f) if it is, returning the instruction and the context that have been saved; and
(g) executing the instruction fetched from the program or the debug support function.

10. The simulation method according to claim 9, further comprising;
before the (c) judging step, executing the instruction fetched from the program,
in the (c) judging step, judging whether the instruction fetched from the program and executed instead of the fetched instruction is the instruction serving as the subject for support,
in the (d) saving step, generating and fetching, if the instruction fetched from the program and executed is judged to be the instruction serving as the subject for support in the (c) judging step, saving the context and generating the stack frame for invoking the debug support function, and fetching the instruction from the debug support function, and
in the (g) executing step, if the fetched instruction is judged not to be the ending instruction of the debug support function in the (e) judging step, executing the instruction fetched from the debug support function.

11. A simulation method used for debugging a program containing a control operation of hardware, comprising:
(a) obtaining a debug support function for supporting a part or a whole of the control operation in the program serving as a subject for debugging and an execution starting time of the debug support function based on a time when an execution of the program starts;
(b) fetching an instruction from the program;
(c) executing the instruction fetched from the program;
(d) calculating a total time from a start of the program to an end of the execution of the instruction;
(e) judging whether a value of the total time is equal to or larger than a value of the execution starting time of the debug support function;
(f) if the value of the total time is equal to or larger than the value of the execution starting time of the debug support function, saving a context and generating a stack frame for invoking the debug support function, and fetching an instruction from the debug support function; and
(g) judging whether the instruction fetched from the debug support function is an ending instruction of the debug support function;
(h) if it is, returning the context that has been saved; and
(i) if it is not, executing the instruction fetched from the debug support function.

12. A simulation method used for debugging a program containing a control operation of hardware, comprising:
(a) obtaining a debug support function for supporting a part or a whole of the control operation in the program;
(b) fetching an instruction from the program;
(c) executing the instruction fetched from the program;
(d) totalizing an execution time from a start of the program;
(e) detecting a start of an execution of the debug support function;
(f) when the start of the execution of the debug support function is detected, suspending the totalization of the execution time, fetching the instruction from the debug support function and executing it;
(g) detecting an end of the execution of the debug support function; and
(h) when the end of the execution of the debug support function is detected, resuming the totalization of the execution time.

13. A simulation program for allowing a computer to execute a simulation method used for debugging a program containing a control operation of hardware, comprising the operations of:
(a) obtaining a debug support function for supporting a part or a whole of the control operation in the program serving as a subject for debugging and a value of a starting address of the control operation to be supported by the debug support function;
(b) judging whether a value of a program counter indicates the control operation serving as the subject for support based on the obtained value of the starting address;
(c) if the value of the program counter serving as the subject for debugging indicates the control operation serving as the subject for support, modifying the value of the program counter so as to indicate the debug support function;
(d) fetching an instruction from the program serving as the subject for debugging or the debug support function according to the program counter; and
(e) executing the instruction fetched from the program serving as the subject for debugging or the debug support function.

14. The simulation program to be executed by a computer according to claim 13, further comprising the operations of;
in the (a) obtaining operation, obtaining a value of an ending address of the control operation to be supported by the debug support function and a value of a starting address of the debug support function, instead of the value of the starting address of the control operation to be supported by the debug support function,
in the (b) judging operation, judging whether the value of the program counter indicates an ending of the control operation serving as the subject for support based on the obtained value of the ending address, and
in the (c) modifying operation, if the value of the program counter indicates the ending of the control operation serving as the subject for support, modifying the value of the program counter so as to indicate the debug support function.

15. A simulation program for allowing a computer to execute a simulation method used for debugging a program containing a control operation of hardware, comprising the operations of:
(a) obtaining a debug support function for supporting an instruction that performs the control operation in the program serving as a subject for debugging and accesses a memory region;
(b) fetching an instruction from the program serving as the subject for debugging;
(c) judging whether the fetched instruction is an instruction serving as the subject for support;
(d) if it is, saving the fetched instruction and a context, generating a stack frame for invoking the debug support function, and fetching an instruction from the debug support function;
(e) judging whether the fetched instruction is an ending instruction of the debug support function;
(f) if it is, returning the instruction and the context that have been saved; and
(g) executing the instruction fetched from the program serving as the subject for debugging or the debug support function.

16. The simulation program to be executed by a computer according to claim 15, further comprising the operations of;
before the (c) judging operation, executing the instruction fetched from the program,
in the (c) judging operation, judging whether the instruction fetched from the program and executed instead of the fetched instruction is the instruction serving as the subject for support,
in the (d) saving, generating and fetching operation, if the instruction fetched from the program and executed is judged to be the instruction serving as the subject for support in the (c) judging operation, saving the context and generating the stack frame for invoking the debug support function, and fetching the instruction from the debug support function, and
in the (g) executing operation, if the fetched instruction is judged not to be the ending instruction of the debug support function in the (e) judging operation, executing the instruction fetched from the debug support function.

17. A simulation program for allowing a computer to execute a simulation method used for debugging a program containing a control operation of hardware, comprising the operations of:
(a) obtaining a debug support function for supporting a part or a whole of the control operation in the program serving as a subject for debugging and an execution starting time of the debug support function based on a time when an execution of the program serving as the subject for debugging starts;
(b) fetching an instruction from the program serving as the subject for debugging;
(c) executing the instruction fetched from the program serving as the subject for debugging;
(d) calculating a total time from a start of the program serving as the subject for debugging to an end of the execution of the instruction;
(e) judging whether a value of the total time is equal to or larger than a value of the execution starting time of the debug support function;
(f) if the value of the total time is equal to or larger than the value of the execution starting time of the debug support function, saving a context and generating a stack frame for invoking the debug support function, and fetching an instruction from the debug support function; and
(g) judging whether the instruction fetched from the debug support function is an ending instruction of the debug support function;
(h) if it is, returning the context that has been saved; and
(i) if it is not, executing the instruction fetched from the debug support function.

18. A simulation program for allowing a computer to execute a simulation method used for debugging a program containing a control operation of hardware, comprising the operations of:
(a) obtaining a debug support function for supporting a part or a whole of the control operation in the program serving as a subject for debugging;
(b) fetching an instruction from the program serving as the subject for debugging;
(c) executing the instruction fetched from the program serving as the subject for debugging;
(d) totalizing an execution time from a start of the program serving as the subject for debugging;
(e) detecting a start of an execution of the debug support function;
(f) when the start of the execution of the debug support function is detected, suspending the totalization of the execution time, fetching the instruction from the debug support function and executing it;
(g) detecting an end of the execution of the debug support function; and
(h) when the end of the execution of the debug support function is detected, resuming the totalization of the execution time.
